(19) United States
(12) Patent Application Publication
(10) Pub. No.: US 2012/0310549 A1
(43) Pub. Date: Dec. 6, 2012

(54) MOLECULE ALIGNMENT

(75) Inventor: Robin Taylor, Hertfordshire (GB)

(73) Assignee: CAMBRIDGE CRYSTALLOGRAPHIC DATA CENTRE, Cambridge (GB)

(21) Appl. No.: 13/459,456

(22) Filed: Apr. 30, 2012

Related U.S. Application Data
(60) Provisional application No. 61/491,714, filed on May 31, 2011.
(60) Provisional application No. 61/512,721, filed on Jul. 28, 2011.

(51) Int. Cl. G06F 19/16; G06F 19/00

(52) U.S. Cl. 702/27; 703/11

(57) ABSTRACT

Provided is a computer-based method of aligning a plurality of molecules including: (i) providing one or more conformers for each molecule; (ii) identifying triplets for each conformer; (iii) determining a triplet type for each triplet; (iv) identifying a base triplet type; (v) rotating and translating the conformers having the base triplet type to overlay the conformers so that the triplets providing the base triplet type are superposed in the same orientation; (vi) for each overlayed conformer, determining a respective bit string fingerprint which encodes the 3D positions of the conformer's fitting points and their respective pharmacophore features relative to the triplet providing the base triplet type; and (vii) aligning the molecules by searching the bit string fingerprints for combinations of overlayed conformers, each from a different molecule, which have high concordance in terms of pharmacophore points.

### CROSS REFERENCE TO RELATED APPLICATIONS

This application claims the benefit of and priority, under 35 U.S.C. §119(e), to U.S. Provisional Application Ser. No. 61/491,714, filed May 31, 2011, entitled “ALIGNMENT OF MOLECULES BY USE OF CARTESIAN-SPACE FINGERPRINTS,” and to U.S. Provisional Application Ser. No. 61/512,721, filed Jul. 28, 2011, entitled “MOLECULE ALIGNMENT” both of which are incorporated herein by this reference in their entirety.

### FIELD OF THE INVENTION

The present invention relates to a computer-based method of aligning molecules using Cartesian (i.e. 3D) position fingerprints.

### BACKGROUND OF THE INVENTION

Ligand-based design techniques such as pharmacophore analysis' and 3D quantitative structure-activity relationships (3D QSAR)² are widely used in drug and agrochemical invention. They usually require the alignment of a set of biologically-active ligands known to bind to the same protein. When the protein structure is unknown, as is often the case, the likelihood that a given overlay is correct can be judged by the extent to which it places similar groups from different ligands close together in space, and on the energies of the ligand conformations. If the ligands are flexible, there can be an enormous number of ways in which they could be overlaid. The problem is therefore challenging. New molecular-overlay algorithms continue to be published³⁻¹⁶, suggesting that the state of the art is not considered satisfactory.

In the absence of the protein structure, the molecular-overlay problem is under-determined. Except in trivial cases, it is therefore unreasonable to suppose that the correct solution can be identified unambiguously. A more realistic aspiration is to produce a small number of significantly different but credible alignments, one of which is close to the truth. Thus, the use of a multiple-objective genetic algorithm (MOGA) for molecular alignment and pharmacophore elucidation¹⁷⁻¹⁹ has been investigated. The method is designed to produce several overlays of a set of ligands using Pareto ranking²⁰ for assessing fitness in multi-objective space. Each overlay represents a different trade-off between the various objective functions measuring overlay quality, e.g. strain energy, volume, matching of hydrogen-bond features. The generation of multiple diverse overlays produces a range of pharmacophore hypotheses to test. It may also challenge preconceived notions about how ligands align and which functional groups are critical to activity.

While the results of these alignment techniques have been promising, several shortcomings warrant further study. For example, some types of hydrophobic features were not properly represented. The scoring protocol sometimes underestimated the degree of hydrogen-bond matching. MOGA optimisation occasionally led to overlays with ligands in strained conformations. The matching of hydrogen-bond and hydrophobic groups was estimated by a single objective function, meaning that an overlay with excellent hydrogen-bond but mediocre hydrophobic matching could not be distinguished from one with the opposite characteristics.

It would thus be desirable to provide an improved method of molecular alignment. It would also be desirable to make the analysis of results easier, to assist users and aid algorithm validation. For example, if a molecular-overlay program produces many possible solutions, it can be time consuming to sift through the output. Good measures of overlay similarity that enable solutions to be clustered, or mapped in 2- or 3-D space are thus needed.

### SUMMARY OF THE INVENTION

Accordingly, a first aspect of the present invention provides a computer-based method of aligning a plurality of molecules, the method including the steps of:
(i) providing one or more conformers for each molecule, each conformer having a plurality of fitting points, each fitting point representing the position of a pharmacophore feature (i.e. a type of chemical group);
(ii) identifying triplets for each conformer, each triplet being a triangular arrangement of three fitting points in the conformer;
(iii) determining a triplet type for each triplet, each triplet type being defined by (a) the types of pharmacophore features at the three fitting points and (b) the inter-fitting point distances of the three fitting points;
(iv) identifying a base triplet type, which is a triplet type provided by a triplet of at least one conformer of each of a plurality of the molecules;
(v) rotating and translating the conformers having the base triplet type to overlay the conformers so that the triplets providing the base triplet type are superposed in the same orientation;
(vi) for each overlayed conformer, determining a respective bit string fingerprint which encodes the 3D positions of the conformer's fitting points and their respective pharmacophore features relative to the triplet providing the base triplet type; and
(vii) aligning the molecules by searching the bit string fingerprints for combinations of overlayed conformers, each from a different molecule, which have high concordance in terms of pharmacophore points, a pharmacophore point being a cluster of fitting points from different molecules in the overlayed conformers, each fitting point in the cluster representing the same type of pharmacophore feature. The degree of concordance is typically dependent on the number and sizes of pharmacophore points, where the size of a pharmacophore point is the number of fitting points in the respective cluster. Thus an increase in the number of pharmacophore points and/or the number of fitting points in the pharmacophore points is generally deemed to correspond to a higher concordance.

The molecules and their conformers are divided into pharmacophore features, which are chemical group types such as hydrogen-bond donors and acceptors (referred to in the following as simply donors and acceptors), hydrophobic groups (hydrophobes), etc. Each feature is represented by one or more fitting points placed at strategic positions, e.g. on a donor atom or at the centroid of a hydrophobic group. A cluster of fitting points in an overlay, all representing the same type of feature and each from a different ligand, constitutes a pharmacophore point. If every molecule contributes, it is termed a full pharmacophore point; otherwise it is a partial pharmacophore point. The complete collection of pharmacophore points present in an overlay (optionally rejecting partial points involving less than a specified number of ligands) is the pharmacophore hypothesis (or, for brevity, pharmacophore) suggested by that overlay. The overall composition of the pharmacophore (i.e. the features that contribute to the pharmacophore points) is the feature mapping of the overlay.

The molecules typically include real molecules (i.e. actual or plausible molecules defined by atoms and the bonds between those atoms). However, additionally or alternatively, as discussed in more detail below, the molecules can include notional supermolecules having the combined pharmacophore features of overlayed real molecules.

Advantageously, in the method of the first aspect every overlay generated must have at least three full pharmacophore points, corresponding to the base triplet. However, the method can take into account partial as well as full pharmacophore points and can be sensitive to whether two features in different molecules are exactly aligned (e.g. map to the same grid point) or only closely aligned (e.g. map to adjacent grid points). A large number of trial conformer combinations can be tested using the method, but the results can be readily processed so that a user is presented with a filtered subset of high concordance combinations for further analysis.

A second aspect of the present invention provides a method for identifying possible ligands of an organic or biological macromolecule, the method including:
performing the method of the first aspect to align known ligands of the macromolecule; and
screening, in silico, a compound database for possible ligands of the macromolecule by identifying compounds which have arrangements of pharmacophore features which are the same as or similar to the arrangements of pharmacophore points found in high concordance combinations from step (vii).

A third aspect of the present invention provides a method for identifying possible ligands of an organic or biological macromolecule, the method including:
performing the method of the first aspect to align known ligands of the macromolecule; and
designing, in silico, compounds which are possible ligands of the macromolecule, the compounds having arrangements of pharmacophore features which are the same as or similar to the arrangements of pharmacophore points found in high concordance combinations from step (vii).

For example, the second or third aspect may include the further step, after the performing step but before the screening/designing step, of merging the fitting points of high concordance combinations from step (vii) to generate respective arrangements of fitting points having the combined pharmacophore features of the aligned ligands. The merged fitting points can then be used in the screening/designing step to identify/design the possible ligands.

A fourth aspect of the present invention provides a method for testing possible ligands of an organic or biological macromolecule, the method including:
performing the method of any one of the first to third aspects to identify possible ligands of the macromolecule;
obtaining or creating the possible ligands; and
testing, in vitro, the possible ligands thus-obtained or created for binding activity with the macromolecule.

A fifth aspect of the present invention provides a computer system for performing the method of any one of the first to third aspects.

For example, a computer system for aligning a plurality of molecules may have:
an input arrangement for inputting one or more conformers for each molecule, each conformer having a plurality of fitting points, each fitting point representing the position of a pharmacophore feature;
one or more processor units operatively connected to the input arrangement and adapted to:
   identify triplets for each conformer, each triplet being a triangular arrangement of three fitting points in the conformer,
   determine a triplet type for each triplet, each triplet type being defined by (a) the types of pharmacophore features at the three fitting points and (b) the inter-fitting point distances of the three fitting points,
   identify a base triplet type, which is a triplet type provided by a triplet of at least one conformer of each molecule,
   rotate and translate the conformers having the base triplet type to overlay the conformers so that the triplets providing the base triplet type are superposed in the same orientation,
   for each overlayed conformer, determine a respective bit string fingerprint which encodes the 3D positions of the conformer's fitting points and their respective pharmacophore features relative to the triplet providing the base triplet type, and
   align the molecules by searching the bit string fingerprints for combinations of overlayed conformers, each from a different molecule, which have high concordance in terms of pharmacophore points, a pharmacophore point being a cluster of fitting points from different molecules in the overlayed conformers each fitting point in the cluster representing the same type ofpharmacophore feature; and
an output arrangement operatively connected to the processor units for outputting the high concordance combinations. The system may have one or more computer-readable storage devices (e.g. computer-readable databases, RAM, ROM, hard disk drives, solid state drives, CDs, etc.) storing the conformers and operatively connected to the input arrangement. The system may have one or more computer-readable storage devices operatively connected to the output arrangement for storing the high concordance combinations. The system may have one or more displays for displaying the conformers and/or the high concordance combinations. The one or more processor units may be adapted to calculate the locations of the fitting points for each conformer before the triplets of each conformer are identified.

A sixth aspect of the present invention provides a computer program product carrying a computer program for performing the method of any one of the first to third aspects.

A seventh aspect of the present invention provides a computer program for performing the method of any one of the first to third aspects.

Optional features of the invention will now be set out. These are applicable singly or in any combination with any aspect of the invention.

Preferably, in step (iv), a base triplet type is identified, which is a triplet type provided by a triplet of at least one conformer of each molecule. Preferably, in step (vii), each high concordance combination contains a conformer of each molecule. However, the method can be used to find high concordance combinations involving conformers from most but not all of the molecules. This can be relevant if one or some of the molecules do not bind in the same way as all the other molecules. Thus, for example, a molecule may not contribute to a high concordance combination because the molecule does not have at least one conformer which has a triplet providing the base triplet type, or because all the conformers of the molecule are rejected at the aligning step.

The molecules are typically flexible molecules. Thus, each molecule can have a large number of conformers.

The conformers are preferably low-energy conformers. These can be generated for each molecule using conventional procedures, e.g. computer-based software conformer generators.

In step (iii), the pharmacophore features can include: donors, acceptors, hydrophobes, metal coordinators, positive centres and negative centres. In addition, user-defined features can be included, e.g. where it is known they are important to binding. For example, specific chemical groups, such as sulfonamide or sulfamate groups can be defined as features in carbonic anhydrase ligands.

In step (vi), the bit string fingerprints may conveniently be combined into a fingerprint table in which each row of the table corresponds to a different bit string fingerprint and each column of the table corresponds to a particular 3D position and type of pharmacophore feature, and, in step (vii), each high concordance combination is scored for concordance by logically combining the columns of the table for the rows of the table corresponding to the conformers of that combination. By using the table in this way, large numbers of trial combinations of overlayed conformers can be rapidly scored in step (vii) and high concordance combinations thus identified. The bits in the bit string fingerprints are either “on” or “off”. Each trial combination of rows can then, for example, be given a score, B, according to the expression:

B=fA−O

A is the number of bits set on in the bit string obtained by logically ANDing the trial combination of rows. For example, if the trial combination comprises the three rows:
10001011
11000010
11110011
   (for clarity, these are much shorter than would be encountered in practice), the result of the AND operation will be
10000010
   because only the first and seventh columns contain an on bit in all rows. The value of A is therefore 2. O is the number of bits set on in the bit string obtained by logically ORing the trial combination of rows. For example, ORing the trial combination above produces:
11111011
   because, in every column except the sixth, there is at least one row that has an on bit. O is therefore 7. f is an integral weight (for example f=2). A high B score is associated with a high concordance combination. Various approaches, such as simulated annealing or greedy algorithms, can then be used to find high concordance combinations. Other approaches are known to the skilled person. Preferably, in step (vi), empty columns of the table are eliminated. This can reduce the computational burden of scoring trial combinations. Additionally or alternatively, other techniques known to the skilled person can be used, however, to compress the bit string fingerprints and thereby increase the speed of logical operations.

In step (vi), the 3D positions of the conformer's fitting points may conveniently be encoded in the respective bit string fingerprint by assigning bits in the bit string to respective grid points of a 3D grid of points, a bit being set “on” if the respective grid point of the 3D grid of points is the nearest grid point to a fitting point. The same grid point may be encoded a plurality of times in the fingerprint depending on the number of defined pharmacophore feature types, a bit being set “on” if (1) the respective grid point of the 3D grid of points is the nearest grid point to a fitting point and (2) the bit is for the pharmacophore feature type of that fitting point. For example, there may be as many bits in the bit string as there are combinations of grid points and defined pharmacophore feature types. Thus, if there are N points in the grid and M types of pharmacophore features, there can potentially be N×M bits in the string (although this number may be reduced by compression techniques such as the removal of empty columns). Each combination of grid point and pharmacophore feature type can thus be assigned to a particular bit in the bit string, that bit being set “on” if the respective grid point of the 3D grid of points is the nearest grid point to a fitting point representing a pharmacophore feature of the respective type. Preferably, nearest-neighbour bits of the nearest grid point to a fitting point are also set “on”. This, advantageously, allows the method to include near misses (two fitting points mapping to adjacent grid points) in high concordance combinations as well as including exact matches (two fitting points mapping to the same grid point) in such combinations. Indeed, this approach can be extended such that bits falling within the volume envelope of the conformer may also be set “on”. The extra “on” bits can then be determined by atomic positions and radii rather than just fitting point positions. The result can be a fingerprint which captures the shape of the conformer. As a result, searching for high concordance combinations may be equated to searching for conformers whose volumes overlap well. This can be advantageous as an attribute of good overlays is often their low union volume.

Typically, steps (iv) to (vii) are performed again for further base triplet types. Preferably, between steps (iii) and (iv), the triplet types that occur most often in the conformers are identified, and a different one of these triplet types is used at each re-performance of steps (iv) to (vii). The high concordance combinations from all the performances of steps (iv) to (vii) can then be pooled for subsequent analysis.

In step (iii), each triplet type may extend over respective ranges (i.e. distance bins) of the inter-fitting point distances of the three fitting points, the ranges of the triplet type determined for each triplet enclosing the values of the respective inter-fitting point distances of the three fitting points of that triplet. Preferably, the respective ranges are non-overlapping so that each inter-fitting point distance can be uniquely assigned to one range. The triplets from the different conformers providing the base triplet type in step (v) are therefore generally not all exactly identical in terms of their inter-fitting point distances. Thus, an exact superposition of the triplets is usually not possible. An approximate superposition can be achieved by least-squares fitting, or by rotating and translating each triplet so that the centroid of the three fitting points of the triplet is at the origin, the first fitting point of the triplet lies along a defined direction (for example, the positive x axis), and the second fitting point lies in a defined plane and on a defined side with respect to the first fitting point (for example, in the xy plane with positive y). For this purpose, the ordering of the fitting points of a triplet as “first”, “second” and “third” can be achieved by canonicalization, based first on the types of pharmacophore features that the fitting points represent and, if that is insufficient to order the fitting points unambiguously, on the distance bins to which the inter-fitting-point distances involving each fitting point belong. If this is still insufficient to order the fitting points unambiguously, the triplet is degenerate, and all valid orders can be used, for example each giving rise to a separate bit string fingerprint.

The use of ranges or distance bins can lead to a problem in that triplets that are identical in all respects except for a small difference in one inter-fitting point distance will be assigned to different triplet types if the slightly different distances fall either side of a range beginning or end value. Thus, preferably, steps (iii) to (vii) are repeated two or more times, the beginning and end values of the ranges of the inter-fitting point distances of the triplet types being altered for each repeat. In this way, even if two near-identical triplets are assigned to different triplet types in one repeat, they can be assigned to the same triplet type in a next repeat. Each repetition typically includes any re-performance of steps (iv) to (vii) for further base triplet types. However, typically no more than two repetitions are necessary.

The method generally includes a further step of: (viii) filtering the high concordance combinations from the or each execution of step (vii) to produce a smaller subset of high concordance combinations. In this way, the task of analysing the high concordance combinations can be made tractable for a user, who may then just focus on the smaller subset of combinations. In particular, a score, such as the B score discussed above, is generally quick to calculate, but may be a relatively crude measure of overlay quality. More refined scoring techniques, based for example on slower but more discriminating objective functions, can therefore be used to filter the high concordance combinations. Thus, step (viii) may include the sub-steps of: (viii-1) scoring the high concordance combinations using an objective function; (viii-2) selecting the high concordance combination having the best value of the objective function; (viii-3) removing high concordance combinations that are similar to the combination selected in sub-step (viii-2); and (viii-4) repeating sub-steps (viii-2) and (viii-3) one or more times for the remaining high concordance combinations; wherein the selected high concordance combinations form the subset. Various objective functions can be used. One option is a volume score, for example, the union volume of all conformers in the combination, a smaller score generally being considered better. Another option is a hydrogen bond score which rewards overlays containing tight clusters of donors or acceptors from many conformers that can hydrogen-bond in a common direction, are sterically accessible and are of similar hydrogen-bonding strengths. A further option is a hydrophobic score which rewards overlays in which directional hydrophobes from different conformers are in close proximity and arranged in a coplanar or approximately coplanar manner. Yet another option is an energy score, which is the sum of the strain energies of the overlaid conformers. The objective function may combine a plurality of such scores, e.g. in a Pareto ranking.

In order for the basic method to align all the molecules, it is necessary that the or each base triplet occurs in at least one conformer of each molecule. If a molecule(s) of interest does not have the base triplet(s), however, it is still possible to generate alignments between such molecules (“unaligned molecules”) and molecules that have been successfully aligned. In particular, after filtering, the method may include the further steps of: (ix) for each high concordance combination in the subset, merging the fitting points of the overlayed conformers to generate an arrangement of fitting points corresponding to a conformer of a notional supermolecule having the combined pharmacophore features of the overlayed molecules; and (x) repeating steps (ii) to (vii) with the conformers of these steps being the supermolecule conformers and the conformers of one or more other molecules (which are typically unaligned molecules, but can also be molecules which were not used in the initial performance of steps (ii) to (vii)). The result of repeating step (vii) can then be an alignment of the supermolecule and the other molecules, the alignment taking the form of high concordance overlays, each overlay containing a conformer of the supermolecule and a conformer of the or each other molecule. Optional features relating to the initial performance of steps (i) to (vii) are also optional features of the repeat performance of steps (ii) to (vii) in step (x). The method may include a further step of: (xi) filtering the high concordance combinations resulting from the performance of step (x) to produce a smaller subset of high concordance combinations.

The “stepwise” approach can be repeated as many times as necessary. Further, the other molecules can themselves be supermolecules so that supermolecules can be superimposed on other supermolecules. Indeed, some or all of the molecules in the initial performance of steps (i) to (vii) can be supermolecules, so that the starting point for the method includes supermolecules.

Typically, the molecules are known ligands of a given organic or biological macromolecule, such as a protein molecule. An advantage of the method is that the structure of the ligand binding site of the macromolecule may be unknown, or indeed, more generally, the structure of the macromolecule may be unknown.

Further optional features of the invention are set out below.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Embodiments of the invention will now be described by way of example with reference to the accompanying drawings.

FIG. 1 shows an example cluster of nitrile, carbonyl and phosphate acceptors, showing positions of virtual points (light blue: nitrile, mid-green: carbonyl, yellow-green: phosphate) representing likely positions of a protein donor.

FIG. 2 shows schematically a conformer of a ligand with 11 fitting points, four being hydrophobes (green spheres), five being acceptors (red spheres), and two being donors (blue spheres).

FIG. 3 shows schematically a triplet from a conformer, the triplet comprising two hydrophobes (green circles) and one acceptor (red circle). Distance bins for the three inter-point distances of the triplet are also shown.

FIG. 4 schematically illustrates a fingerprint creation operation for a conformer in respect of a grid.

FIG. 5 schematically illustrates, in the context of the grid of FIG. 4, overlayed fitting points of a plurality of conformers, and respective rows in a schematic fingerprint table.

FIG. 6 schematically illustrates a fingerprint table having conformers from three ligands, and the concordance scoring of a combination of three conformers from the table.

FIG. 7 schematically illustrates a fingerprint table having conformers from four ligands, and the ligand and conformer counting for each column.

FIG. 8 schematically illustrates the fingerprint table of FIG. 7, and the summing of the ligand and conformer counts.

FIG. 9 shows stick representations (in white, orange, green and magenta) of respective conformers of four ligands in their true, crystallographically-observed overlay.

FIG. 10 shows two overlays of dihydrofolate reductase ligands with identical feature mappings but different ligand conformations.

FIG. 11 is a map of overlays of cycle checkpoint kinase ligands showing two distinct clusters of solutions and two outliers.

FIG. 12 illustrates a true overlay of neprilysin (NEP) ligands and shows clusters A-D of pharmacophoric atoms.

FIG. 13 shows two predictions for protein kinase 5 ligands. The top one is similar to the true overlay, the bottom one is a credible alternative with ligand acid groups overlaid.

FIG. 14 shows top ranked solution for fatty acid binding protein ligands before (top) and after (bottom) refinement.

FIG. 15 shows the second-ranked solution for neprilysin ligands (carbons coloured green) superimposed on true overlay (carbons in purple).

FIG. 16 shows, at top, the true overlay of the ligands from the cycle checkpoint kinase complexes 2br1, 2brb, 2brg, 2brh, 2brm, 2bro (carbons in purple) superimposed on the corresponding ligands from one of the correct solutions obtained for the Chk1 test series (carbons in green, remaining ligands in series omitted for clarity), and, at bottom, the same true overlay superimposed on ligands 2br1 . . . 2bro from one of the incorrect outlier solutions. Both have the requisite cluster of donor and acceptor atoms (circled) but the acceptor cluster in the incorrect solution involves the wrong pyrimidine nitrogen.

FIG. 17 shows, at top, the true overlay of four of the neuraminidase ligands (1a4g, 1a4q, 1b9t, 1inf), and, at bottom, the positions of the same ligands in the best predicted overlay (remaining ligands in series omitted for clarity). In both, two cationic groups (shown in ball-and-stick style) lie on one side of the overlay and two on the other.

FIG. 18 shows the true overlay of three adenosine deaminase ligands from PDB complexes 1o5r, 1ndv and 1wxy (carbon atoms coloured in green, purple and orange, respectively).

FIG. 19 shows the true overlay of ten heat shock protein ligands, showing the poor volume overlap of three ligands (from PDB complexes 1byq, 1uy8, 1yet, coloured in purple) with the remainder (1yc1, 1yc4, 2bsm, 2byi, 2bz5, 2cct, 2uwd, coloured in green).

FIG. 20 shows the overlay (left) and top-ranked prediction (right) for a subset of acetylcholinesterase ligands (1h23, 1w4l, 1zgb, 2ckm). The heterocyclic systems at the top are more closely aligned in the prediction than in the true overlay.

### DETAILED DESCRIPTION AND FURTHER OPTIONAL FEATURES OF THE INVENTION

We have developed a program for aligning multiple flexible molecules. Input consists of a set of low-energy conformers for each molecule. The program represents each conformer by a set of fitting points placed at the positions of key chemical features (hydrogen-bond donor and acceptor atoms, hydrophobic groups). For each conformer, all combinations of three fitting points (“triplets”) are enumerated and each assigned to a type, defined by the natures of the three chemical groups represented by the points of the triplet and the binned inter-point distances. Triplet types that do not occur in at least one conformer of every molecule are typically rejected. Each of the most commonly occurring of those that remain is used to construct a fingerprint. The fingerprint built from a given triplet type captures, as a series of bit strings, the positions of all fitting points when conformers containing a triplet of that type (the “base triplet”) are aligned so that the points of the base triplet are in a standard position and orientation. This enables a fast search to be performed to find combinations of the aligned conformers, one from each molecule, that have chemically similar fitting points at similar positions in space. Conformer combinations thus found are used to build trial overlays. The overlays generated from all fingerprints are pooled, scored on three objective functions (union volume, hydrogen-bond match, and hydrophobe match), ranked by constrained Pareto ranking, and a diverse subset of the best-ranked overlays selected and presented to the user using an overlay-dissimilarity measure. Overlays may be further refined, for example, by simulated annealing, and a multi-objective genetic algorithm can be used to find additional overlays with a given mapping of chemical features but different ligand conformations (a process termed “overlay multiplication”). A stepwise approach allows an overlay of several ligands to be built up sequentially. The program has been tested on ten sets of ligands taken from protein-ligand crystal structures in the Protein Data Bank (PDB²¹), for each of which the true overlay is known from x-ray structures of protein-ligand complexes. Good results are obtained on the majority of these series.

### Methods

Nomenclature.

The molecules and their conformers are divided into pharmacophore features, such as hydrogen-bond donors and acceptors (referred to in the following as simply donors and acceptors), hydrophobic groups (hydrophobes), etc. Each feature is represented by one or more fitting points placed at strategic positions, e.g. on a donor atom or at the centroid of a hydrophobic group. A cluster of fitting points in an overlay, all representing the same type of feature and each from a different ligand, constitutes a pharmacophore point. If every molecule contributes, it is termed a full pharmacophore point; otherwise it is a partial pharmacophore point. The complete collection of pharmacophore points present in an overlay (optionally rejecting partial points involving less than a specified number of ligands) is the pharmacophore hypothesis (or, for brevity, pharmacophore) suggested by that overlay. The overall composition of the pharmacophore (i.e. the features that contribute to the pharmacophore points) is the feature mapping of the overlay.

Ligand Preparation.

The ligands are built in the protonation states they are expected to adopt at the protein binding site, as these are not altered during the overlay process. A set of low-energy conformers is generated for each ligand. We have used OMEGA²² for this, but expect that other conformer generators would also be suitable.

Pharmacophore Feature Definition and Fitting-Point Placement.

Two types of hydrophobic feature are defined, directional and non-directional. The former are groups that are more likely to form hydrophobic interactions in some directions than others. Examples are aromatic rings (for instance, phenyl groups usually form hydrophobic interactions above and below the ring plane but often form CH . . . O interactions around the ring edge²³) and peptide linkages. It may seem odd to define peptide as a hydrophobe but inspection of protein-ligand crystal structures shows that this group tends to form hydrophobic interactions above and below the peptide plane, although interactions in the plane are invariably hydrogen bonds. Non-directional hydrophobes are groups that are equally hydrophobic in all directions, e.g. alkyl chains. Hydrophobes are represented by a fitting point at the centroid. Optionally, for certain planar hydrophobic groups (most notably aromatic rings) it may be desirable to also include two fitting points along the normal to the plane of the group (one in each direction; above and below the plane). Prior to overlay scoring, this gives more combinations of triplets to search over. A result is that the program can better cope with examples where there are relatively few features in common between the starting molecules, as it places more emphasis on planar hydrophobic group alignment in these cases.

The algorithm for defining hydrophobic features is fairly similar to that used in other programs²⁴. All rings of size≦6 are classed as hydrophobes (directional if all ring atoms are delocalisable, otherwise non-directional). Tertiary groups such as t-butyl and CF₃ are considered non-directional hydrophobes. Groups such as peptide and isolated C═C, C═N and N═N linkages are classed as directional hydrophobes. Finally, remaining hydrophobic (i.e. not N or O) portions of the molecule (acyclic chains, rings of size>6) are divided into segments of up to four atoms, each segment constituting a separate non-directional hydrophobe. Segments of only three or two atoms are chosen if it leads to a more uniform placement of fitting points (e.g. an unbranched chain of nine carbons is divided into three segments of three atoms).

The definition of all other feature types is customisable and driven by SMARTS strings²⁵. In principle, an unlimited number of feature types may be defined, e.g. donors, acceptors, metal coordinators, positive and negative groups, etc. It is merely necessary to provide a list of SMARTS strings defining the substructures that belong to the given feature type. In practice, we generally only use donor and acceptor types (the latter serving also as a surrogate for metal coordinators) and anticipate that a small number of program changes would be necessary to take advantage of additional feature-type definitions. We do not think positive and negative features are worthwhile but make a distinction between ionised and neutral hydrogen-bonding groups when scoring.

Each SMARTS string defining a particular type of donor or acceptor must be accompanied by two extra data items. One defines the strength of the hydrogen bonds formed by the group, categorised as 3 (strong), 2 (medium) or 1 (weak). The former is reserved for ionised groups, and the latter used for donors such as thiols and activated C—H groups and acceptors such as thiourea sulfur. The strength can also be set to 0 (does not hydrogen bond), which is a convenient way of excluding atoms such as furan oxygen which almost never hydrogen bond. The second data item specifies the preferred geometry of the hydrogen bonding group. For example, two-coordinate sp² nitrogen is defined as a trigonal acceptor (preferentially forms hydrogen bonds along its sp² lone-pair direction).

The location of donor and acceptor fitting points is customisable but in practice we generally place them on the donor and acceptor atoms rather than on lone-pair and donatable hydrogen positions, or at the inferred position(s) of the complementary hydrogen-bonding atom(s) on the protein. Our choice makes it more difficult to find overlays in which two ligand atoms can hydrogen bond to the same protein atom even though they are not close to each other (for example, two donors might be several Angstroms apart and still donate to different lone pairs of the same protein carbonyl oxygen). On the other hand, fitting points at hydrogen, lone pair or inferred protein-atom positions introduce problems of their own. They make the search space larger (for example, may require hydrogen-atom torsions to be varied) and points lying outside the molecular envelope (i.e. at inferred protein-atom positions) tend to have unduly large leverage during overlay generation. However, analogously to the case where extra fitting points are included along the normal to the plane of planar hydrophobic groups, it may be desirable to include fitting points on lone-pair and donatable hydrogen positions (and optionally on other points around an acceptor atom corresponding to favourable H-bonding directions) as well as on the donor and acceptor atoms. The extra fitting points generate more triplets and, as a consequence, more emphasis is placed on donor/acceptor alignment.

Scoring Functions.

Four scoring functions are used to quantify overlay quality.

Volume Score.

This is the union volume of all ligands, V, calculated using a grid-based algorithm with a default grid size of 0.5 Å. Hydrogen atoms are included. Smaller values of the score are considered better, since ligands need to bind in a protein cavity of limited size.

Hydrogen Bond Score.

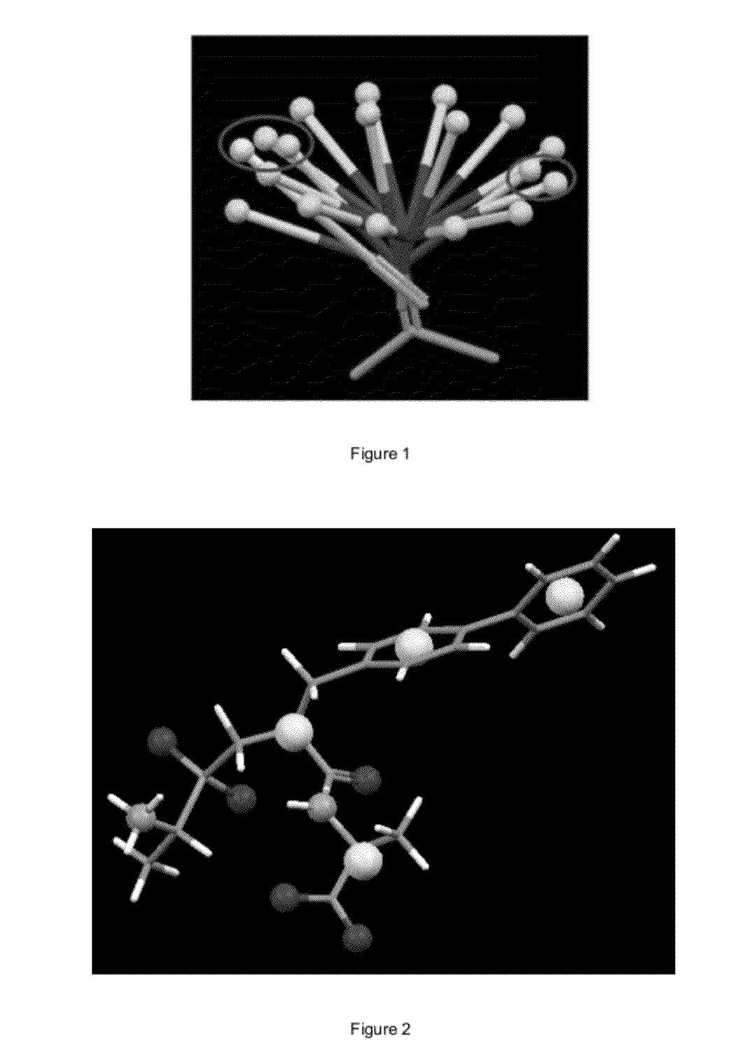

This rewards overlays containing tight clusters of donors or acceptors (from many ligands) that can hydrogen-bond in a common direction, are sterically accessible and of similar hydrogen-bonding strengths. First, a fast leader-style cluster analysis^{26,27} is performed to find clusters of donor or acceptor atoms with no more than one atom from each ligand. The best consensus hydrogen-bonding direction for the donors or acceptors in each cluster is found. Consider, for example, a cluster containing the three acceptors phosphate oxygen, carbonyl oxygen and nitrile nitrogen. “Virtual points” are generated to represent the positions at which the complementary protein donor might lie for each acceptor. See, for example, FIG. 1 which shows an example cluster of nitrile, carbonyl and phosphate acceptors, showing positions of virtual points representing likely positions of a protein donor. Two virtual-point clusters are circled; the one on the left is better as it involves points from all three acceptors. Twelve points are placed for phosphate oxygen, evenly spaced on the base of a cone of semi-angle (180-109.5)° whose axis lies along the P-0 direction, with each point 3 Å from the oxygen atom. Five points are used for carbonyl oxygen (in the sp² lone-pair directions and at evenly-spaced intermediate positions on the arc 3 Å from the oxygen atom) and one for nitrile nitrogen (3 Å from the nitrogen on the sp axis). Cluster analysis is used to find the largest cluster of virtual points, representing the best consensus direction for hydrogen bonding. The size of the largest cluster might be less than the size of the parent acceptor- or donor-atom cluster, indicating that not all of the donors or acceptors can hydrogen-bond in the same direction.

Steric accessibility is assessed by generating points on the line between the centroid of the donor or acceptor atoms and the centroid of the chosen virtual-point cluster, at 2.1, 2.4, 2.7 and 3.0 Å from the former. Each point is examined to determine whether it falls within the hydrophobic envelope of the overlay (for efficiency, this exploits the occupancy grid already set up for volume calculation) and the results converted to an occlusion factor, X, which varies from 1 if there is a clear line of sight to 0.1 if the points are highly occluded.

Inspection of the protein-ligand structures used to construct our test set showed no example of a protein atom forming hydrogen bonds to a strong donor or acceptor on one ligand but a weak donor or acceptor on another (using our definitions of strong, medium and weak). Hydrogen bonding was always to ligand groups of the same strength or (less commonly) to a mixture of strong and medium or medium and weak. To reflect this, the similarity of the donors or acceptors in each cluster is represented by a factor S, which is set to (m/n)², where n is the actual number of hydrogen-bonding atoms in the cluster and m is an “effective” number. If all atoms in the cluster have the same strength, m is set to n. If there is a mixture of strong and medium (but no weak) or of medium and weak (but no strong), m is set to (2n−1)/2. If there are both strong and weak atoms in the cluster, m is first set to n−n(min), where n(min) is the minimum of n(strong) and n(weak), and then, if the cluster contains medium atoms, further reduced to (2m−1)/2.

The hydrogen-bond score (larger values better), HB, is calculated as:

HB=Σ{SₚXₚ[Aₚ²f(aₚ)+Vₚ²g(vₚ)]}

The summation is over the donor and acceptor clusters (if the same set of hydroxyl groups contributes both to a donor and an acceptor cluster, the contribution of the less well-scoring cluster is ignored). Sₚ and Xₚ are the similarity and occlusion factors for cluster p; Aₚ is the number of donor or acceptor atoms in the cluster; Vₚ is the number of virtual points in the largest virtual-point cluster (in the event of a tie, the score is calculated with each in turn and the highest value taken); aₚ is the mean square distance of the donor or acceptor atoms from their centroid; vₚ is the corresponding quantity for the virtual-point cluster. f(aₚ) is a weighting function which falls linearly from 1.0 to 0.3 as aₚ increases from 0.15 to 0.75 Å², taking constant values of 1.0 and 0.3, respectively, below and above these distances; g(vₚ) is similar in form but falls between 1.0 and 0.3 as vₚ increases from 0.5 to 1.5 Å². The effect is to reward tight clusters.

Hydrophobic Score.

This rewards overlays in which directional hydrophobes from different ligands are in close proximity and arranged in a coplanar or approximately coplanar manner. This arrangement is commonly seen in crystallographically-observed overlays. A fast leader-style cluster analysis is performed to find clusters of directional-hydrophobe centroids (no more than one centroid from each ligand). Inter-planar angles are calculated between all pairs of hydrophobes in each cluster. The score (larger values better), HY, is:

HY=Σ{Nₚ²[f(nₚ)+g(cₚ)]}

The summation is over the clusters. Nₚ is the number of hydrophobes in cluster p; nₚ is the mean-square distance between the hydrophobe centroids and their overall centroid; cₚ is the average cosine of the inter-planar angles. f(nₚ) is a weighting function which falls linearly from 1.0 to 0.0 as nₚ increases from 0.0 to 1.25 Å, remaining constant at zero thereafter, g(cₚ) is similar in form but falls from 2.0 to 0.0 as cₚ decreases from 1.0 to 0.8. Hence, more weight is placed on the hydrophobes being coplanar than on their centroids being coincident.

Energy Score. The energy score, E, is the sum of the strain energies of the overlaid ligands, calculated from the torsional and van der Waals (vdw) terms of the Tripos force field²⁸. Only repulsive atom-atom vdw interactions are included to avoid favouring folded conformations. As bond angles are not allowed to relax, all vdw radii are, by default, reduced to 0.85 times their published values. Also, the worst atom-atom clash is ignored provided its energy is <150 kcal/mol. This makes the function more forgiving in the common situation where a conformation has a single atom-atom clash (often between hydrogen atoms) that could easily be relieved if bond angles were allowed to optimise.

Chromosome Structure.

Any given overlay can be represented by a chromosome, which defines the conformation, position and orientation of each ligand. A ligand conformation is defined by (a) a conformer index, which refers to one of the low-energy conformations supplied by the user, and (b) a set of torsion-angle values for the acyclic rotatable bonds. (A file of SMARTS strings is used to indicate which types of acyclic bonds are to be considered rotatable and can also be used to set allowed torsion-angle ranges. For example, we do not rotate methyl groups, and constrain ester groups to lie within 5° of the trans planar geometry.) The required conformation is generated by setting the molecular geometry to that of the specified conformer and then further driving the rotatable bonds to their required torsion settings. The chromosome may contain no torsion data, in which case the indicated conformer is used directly. When torsion angles are supplied, it is still necessary to specify a conformer index in case the ligand contains a flexible ring or invertible nitrogen, in which case different conformers in the input file might have different ring or nitrogen geometries.

The positions and orientations of the ligands are defined by a mapping table, and rotation and translation data. The mapping table specifies a matching of fitting points. For example, for a three-ligand overlay it might look like:
1 7 9; 4 6 10; 2 4 6

This means that ligand 2 is to be overlaid on ligand 1 (once they have been set to their specified conformations) by least-squares superposition of fitting points 4, 6, 10 of ligand 2 on 1, 7, 9, respectively, of ligand 1. Ligand 3 is overlaid by least-squares superposition of its fitting points 2, 4, 6 on the points a, b, c, where a is the centroid of fitting point 1 (ligand 1) and fitting point 4 (ligand 2), etc. More than three fitting points per ligand can be specified and missing values (indicated by −1) are allowed. It may not be necessary for there to be three fully-occupied columns in the table. For example, the following table for a three-ligand overlay is valid:
−1 9 4 7 1; 5 8 2 −1 −1; 3 −1 6 2 4

Ligand 2 cannot be overlaid directly on either ligand 1 or 3 (only two shared mapping columns in each case) but the overlay can be achieved by superimposing the matched fitting points of ligands 1 and 3 and then superimposing ligand 2 on the ensemble (ligand 1+ligand 3). The program will always find an order in which the ligands can be overlaid if one exists, and the same mapping table will always lead to the same order. If there is no possible order, the chromosome is invalid.

The chromosome may also contain three translations and three Euler angles per ligand. If so, the ligand positions are further modified after the mapping-table operations by rigid-body rotations about the x, y and z directions, followed by translations. This was implemented to allow ligands to rotate and translate freely during overlay refinement. However, the extra degrees of freedom did not seem to improve results so we do not currently use this part of the chromosome.

Overview of Searching Algorithm.

Searching for overlays involves up to four steps: (a) overlay generation, a fast fingerprint technique for generating promising overlays; (b) overlay filtering, which selects a diverse subset of the generated overlays that score well on the above objective functions; (c) overlay refinement, to improve those solutions that have survived the filtering; (d) overlay multiplication, which explores the geometric variability of specific pharmacophore hypotheses. The first two steps are generally critical: if they fail to produce good overlays, it is unlikely that the last two steps will rectify the problem. Conversely, the overlays after the filtering step may, in favourable cases, be good enough that no refinement or multiplication is necessary

Overlay Generation.

This involves three stages: triplet counting, fingerprint calculation and fingerprint searching.

Triplet Counting.

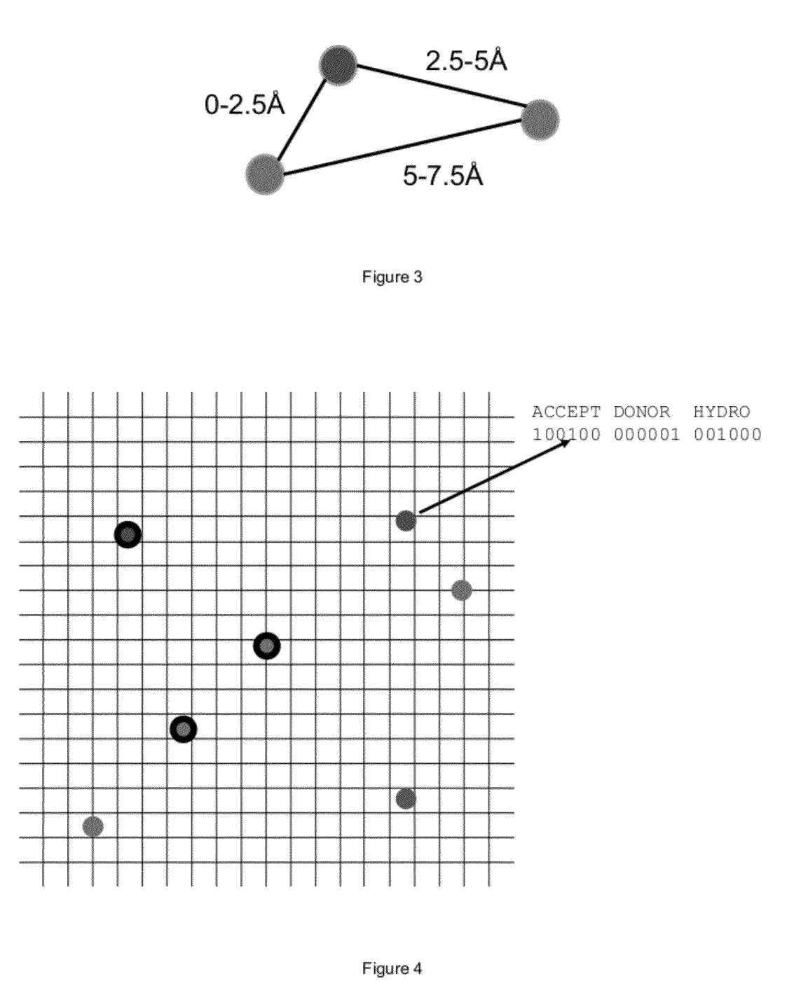

A triplet is defined as three fitting points from the same conformation of a given ligand. FIG. 2 shows schematically a conformer of a ligand with 11 fitting points, four being hydrophobes (green spheres), five being acceptors (red spheres), and two being donors (blue spheres). FIG. 3 shows schematically a triplet from a conformer, the triplet comprising two hydrophobes (green circles) and one acceptor (red circle). Each triplet is assigned to a triplet type, defined by (a) the types of features that the three fitting points represent (i.e. donors, acceptors or hydrophobes), and (b) the inter-fitting point distances. By defining a set of non-overlapping ranges or distance bins (e.g. 0.0 to 2.5, 2.5 to 5.0 Å . . . ), each inter-point distance can be assigned uniquely to one bin, so each triplet can be assigned uniquely to one triplet type. For example, in FIG. 3, the three inter-point distances of the triplet fall in three different distance bins.

The first step is to find the triplet types that occur most often in the ligand conformations that the user has supplied. All triplets are enumerated and assigned to their appropriate triplet types. Let Lᵢ be the number of ligands in which at least one triplet of type i occurs in at least one conformation. Let Pᵢⱼ be the proportion of conformations of ligand j that contain at least one triplet of type i. Let Pᵢ be the average of the Pᵢⱼ over all ligands. Triplet types are sorted first in descending order of Lᵢ and then, in the event of ties, in descending order of Pᵢ. The position of a triplet type in the sorted list is its rank, starting at 1 for the most common. Let M be the rank of the lowest-ranked triplet type that occurs in all ligands. Overlay generation, as described below, proceeds by iterating over the triplet types from rank 1 to N, where N is the lesser of M and a user-defined value (typically 25—it is rarely worth trying more). In each step of the iteration, overlays are generated by least-squares superposition of triplets of the type under consideration in that step. Overlays from all iteration steps are pooled and taken forward to the filtering stage.

The use of distance bins may lead to a problem. Two triplets that are identical in all respects except for a small discrepancy in one of the inter-point distances will be assigned to different triplet types if the slightly discrepant distances fall either side of a bin boundary. For this reason, we run the entire overlay generation procedure twice using different bin definitions. The overlays from each run are pooled together before filtering. By default, the first set of bins is: 0.5-3.0, 3.0-5.0, 5.0-7.0, 7.0-9.0, 9.0-11.0, 11.0-13.0 Å. The second is: 0.5-3.5, 3.5-6.0, 6.0-8.5, 8.5-11.5, 11.5-13.5 Å. (Triplets are ignored if they involve a distance below the lowest bin boundary or above the highest.)

Fingerprint Calculation.

For a given cycle of iteration, let the triplet type under consideration be called the base triplet type, and let a triplet belonging to that type be a base triplet. The aim is to perform a multiple alignment of all ligand conformations containing a base triplet so that, for each such conformation, the base triplet is placed in a standard position and orientation. The positions of the fitting points of each aligned conformation are then captured in a fingerprint. The algorithm loops over all conformations of all ligands. For each conformation, only the fitting points are considered, not the atomic coordinates. If the conformation does not contain a base triplet it is rejected. If it does, the points of that triplet are numbered 1, 2 and 3 by a canonicalization algorithm (donor points awarded lower numbers than acceptors, acceptors lower than hydrophobes; for two points of the same type, the one involved in the lowest distance bin awarded the lower number). The rotation/translation transformation is calculated that places the triplet with its centroid on the origin, point 1 on the x axis, point 2 in the xy plane with positive y. This transformation is applied to all fitting points of the conformation. The resulting fitting-point positions are stored. If the base triplet is degenerate, so that there is no unique canonicalised order, all valid orderings are used in turn, a separate set of fitting-point positions being generated for each. If the conformation contains more than one base triplet, the process is repeated for each in turn.

A 3D grid is constructed, large enough to enclose all of the fitting-point positions generated above, with one extra level in each direction. By default, a grid step-size of 1.5 Å is used. Let the number of points in the grid be G. Each set of fitting points, corresponding to a particular ligand conformation aligned with a base triplet in the standard orientation, is converted to a fingerprint as follows. A bit string of length 3G is created. The first segment of G bits will capture donor fitting-point positions, each bit corresponding to one of the grid points. The other two segments will capture acceptor and hydrophobe fitting point positions. All bits are initialised to 0. Each fitting point in the ligand conformation (except those of the base triplet) is mapped to its nearest grid point and to the six adjacent points in the ±x, y and z directions. Depending on the type of feature that the fitting point represents, the bits corresponding to these seven grid points in the donor, acceptor or hydrophobe segment of the bit string are set to 1. The purpose of setting seven rather than one bit is to “smear” the fitting point out and make the algorithm more forgiving.

FIG. 4 schematically illustrates this fingerprint creation operation for a conformer in respect of a schematic grid, which for the purpose of illustration is only shown as 2D. The circles representing the fitting points of the base triplet of the conformer are indicated with heavy outlines. The three segments of the bit string are each schematically represented by six bits (rather than the about 400 bits that would be required to map the schematic 2D grid). The arrow indicates the correspondence between an acceptor fitting point and a bit of value 1 in the respective segment of the bit string.

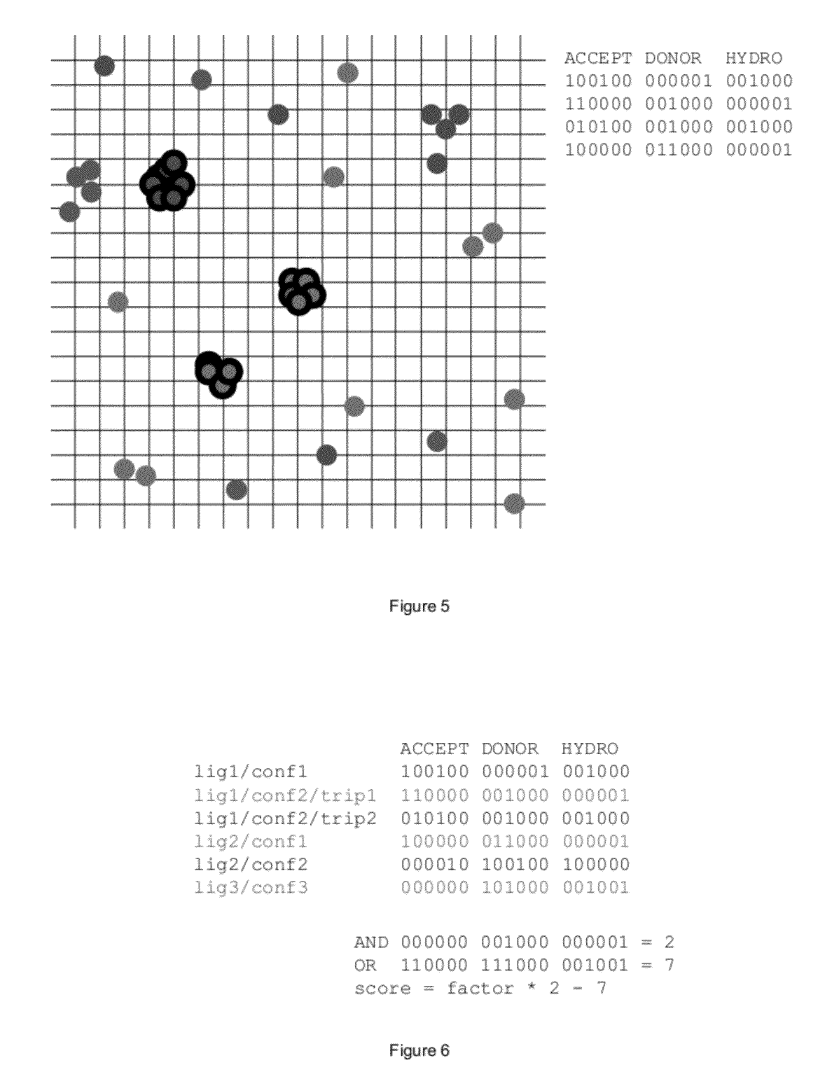

When all sets of fitting points have been processed such that the conformers are overlayed, the result is a fingerprint table (we also call it an alignment fingerprint), each row corresponding to an aligned ligand conformation, each column to a particular grid point and feature type. FIG. 5 schematically illustrates, in the context of the grid of FIG. 4, the overlayed fitting points of a plurality of conformers and respective rows in the fingerprint table. Empty columns in the table can be eliminated. As this is typically the majority, the row lengths are thereby drastically reduced.

Fingerprint searching.

The alignment fingerprint is searched for combinations of rows (one row from each ligand) that have high concordance in terms of pharmacophore points. This is equivalent to searching for ligand conformations (one per ligand) that, when overlaid by superimposing the fitting points of the base triplet, have other fitting points in similar positions in space. Searching for good row combinations is the rate-limiting step of overlay generation but is still relatively quick because it only involves logical bit-string operations and bit counting. Any trial combination of rows is scored by:

B=fA−O

where A is the number of bits set on in the bit string obtained by logically ANDing the trial set of rows; O is the corresponding quantity for the bit string produced by logical OR; and f is an integral weight (we normally use f=2).

A bit value of 1 in the AND string is suggestive of a full pharmacophore point, since the aligned ligand conformations corresponding to the ANDed rows must all have the same type of fitting point mapped to the same grid point. Thus, large values of A are good. Conversely, small values of O are desired, since the more “column sharing” there is (i.e. two or more of the selected rows having “on” bits in the same column), the higher the concordance of the selected rows. O is sensitive both to full and partial pharmacophore points. The larger the weight f, the greater the premium placed on full rather than partial pharmacophore points. The scoring is schematically illustrated in FIG. 6 for a table having conformers from three ligands. Only ligand conformers containing at least one base triplet appear: the first ligand has two such conformers, the second of which contains two base triplets (so contributes two rows to the table); the second ligand has two such conformers; and the third ligand has one. The score is calculated for the combination lig1/conf2/trip1-lig2/conf1-lig3/conf3.

We have tried two methods for finding good row combinations. The first uses simulated annealing, starting from a random row combination (one row per ligand). In each annealing step, a row is chosen at random from the alignment fingerprint and used to replace the row in the current solution that corresponds to the same ligand. The chosen row is retained if it increases the score, otherwise it is accepted or rejected depending on whether or not a randomly generated number exceeds a criterion X. X is steadily increased during the annealing so that acceptance of a changes that decreases the score becomes progressively less likely. Typically, 2000 to 10000 steps are performed.

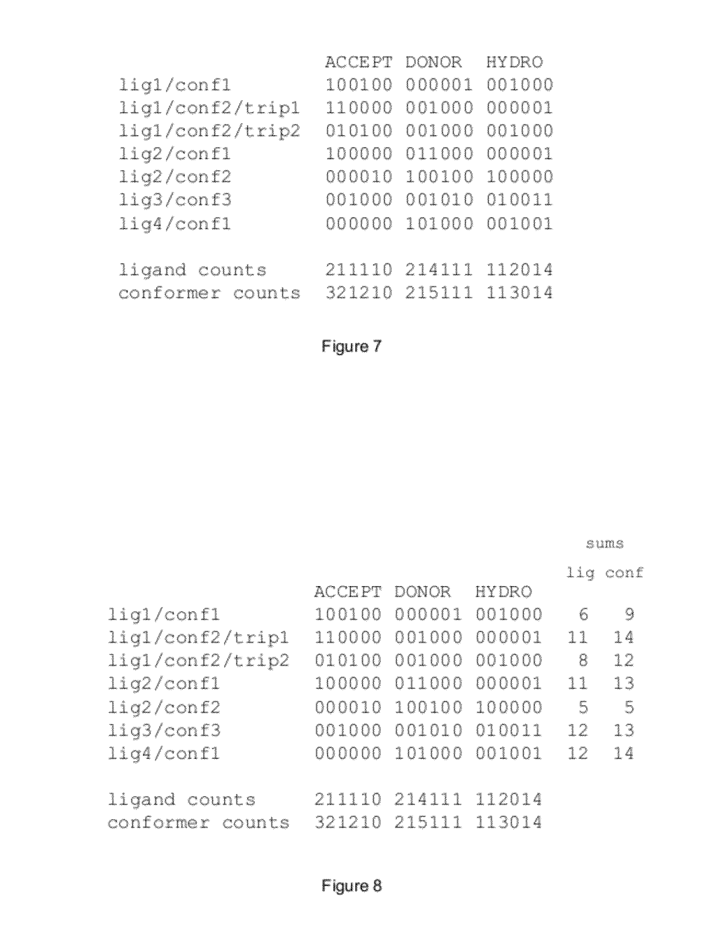

The second method is a greedy algorithm. A starting row is chosen. Selection is biased towards rows containing a large number of “on” bits in highly occupied columns. For example, as schematically illustrated in FIG. 7, a ligand count can be performed for each column of the fingerprint table, a ligand providing a value of 1 to the count if it has at least one conformer with an “on” bit in that column. Similarly, a conformer count can be defined for each column, being the total number of “on” bits in that column. Then, as schematically illustrated in FIG. 8, for each conformer, the ligand counts are summed along the row for that conformer, but only when the counts coincide with “on” bits in the respective columns. A similar procedure is followed for the conformer counts. The conformers are then ranked, such that, for any pair of conformers Y and Z, Y is awarded a higher rank than Z if it has the higher sum of ligand counts. If Y and Z are tied on sum of ligand counts, Y is awarded the higher rank if it has the higher sum of conformer counts. If they are still tied, they are awarded equal ranks. The conformer (or one of the conformers) providing the highest rank can then be selected to provide the starting row for the greedy algorithm (i.e. lig4/conf1). Let the ligand to which this row belongs be called L(1). The remaining ligands are arranged in a random order. Let these ligands be L(i), where i=2, 3, . . . n (n being the total number of ligands). The following process is applied: (a) set i=2; (b) create bit strings BStr(AND) and BStr(OR) by ANDing and ORing, respectively, the rows already selected for ligands L(1), . . . L(i−1); (b) for every row belonging to L(i) in turn, calculate the B score obtained by ANDing and ORing that row with BStr(AND) and BStr(OR), respectively; (c) select the row that gave the best B score (in the event of a tie, select at random from the tied rows); (d) if i=n, stop, otherwise increment i by 1 and go back to step (a). For the subsequent performances of the greedy algorithm, the conformer providing the next highest rank can be selected to provide the starting row, and so on.

The annealing and greedy algorithms seem to be of comparable efficacy; we currently use the latter.

Tests indicate that the B score correlates with both the volume (V) and hydrogen bond (HB) scores. Absolute values of the Pearson correlation coefficient are typically 0.6 to 0.7 (the correlation is negative for V, positive for HB). This is easily large enough to be useful, but still far from perfect. Therefore, we generate many solutions (e.g. 200-300) from each fingerprint. When overlays from all fingerprints and both choices of distance bins are pooled, there are usually of the order of 10,000. They are stored as chromosomes. In each chromosome, the mapping table contains the indices of the fitting points comprising the base triplets of the overlaid ligand conformations.

Stepwise Approach.

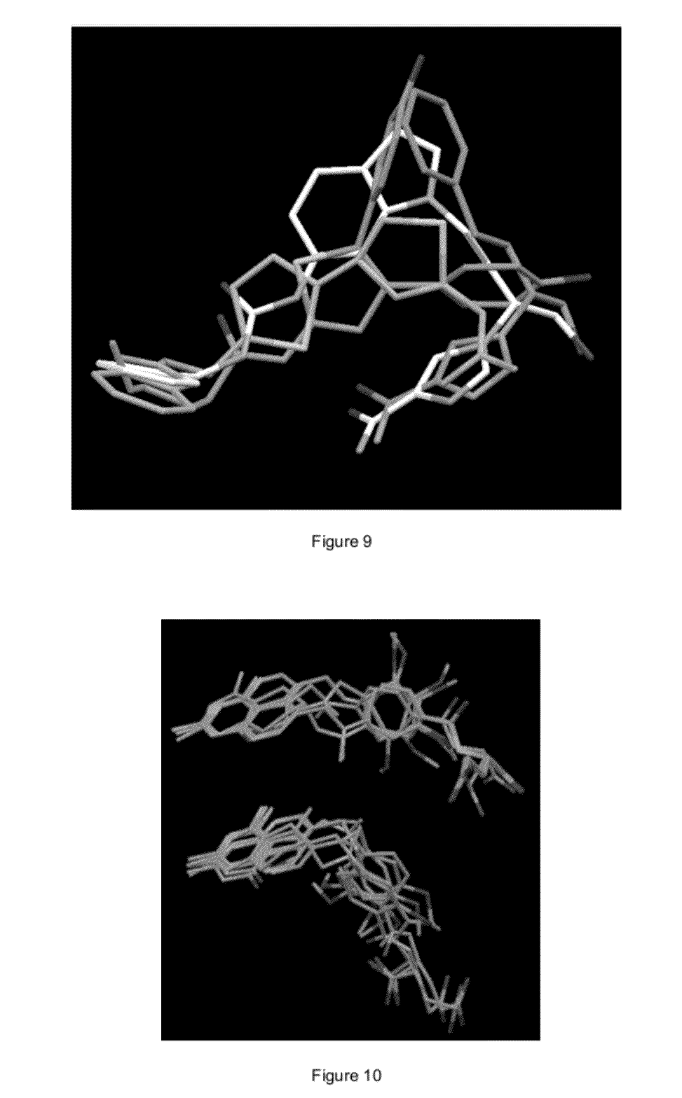

A limitation of the method is that overlays can only be generated from base triplets that occur in at least one conformation of every ligand. A workaround is to create overlays in stepwise fashion. For example, when overlaying ligands 1 to 5, the overlay generation can first be run on ligands 1, 2 and 3 only. After filtering (discussed below), this will result in several overlays of the three ligands. The program can treat these as “conformations” of a “supermolecule”, for each of which fitting points are placed to represent the features of all three ligands. Where fitting points of the same type from different ligands are close together, they are merged into a single average point. A second overlay generation can then be run to overlay the other ligands on the supermolecule. Because the supermolecule has more fitting points than any of its three ligands separately, there is an increased chance of finding common base triplets. The approach is less straightforward because a decision must be made on how to split the ligands. On the other hand, it can be implemented so as to allow users to influence overlay generation by rejecting intermediate overlays they regard as unsatisfactory. FIG. 9 shows stick representations (in white, orange, green and magenta) of respective conformers of four ligands in their true, crystallographically-observed overlay. In this overlay, the green ligand has no triplet that is closely aligned with a similar triplet belonging to the magenta ligand. In consequence, there is no base triplet from which the correct overlay of these two ligands can be produced. However, by overlaying first the white, orange and magenta ligands, and then overlaying the green ligand on the supermolecule of the white, orange and magenta ligands, a substantially correct overlay of all four ligands can be produced.

Overlay Filtering.

Filtering aims to select a diverse subset of the best of the generated overlays. The procedure is to score the overlays, select first the one that scores best, remove from the list any overlay that is closely similar to the one selected, pick the best of those that remain, and so on until no more remain, or until a user-defined maximum is reached. Scoring can use any or all of the objective functions described earlier, either separately or as a weighted linear combination. By default, we use volume, hydrogen bond and hydrophobic scores, but not energy, as all ligand conformations in the generated overlays will have been taken directly from the low-energy conformers supplied by the user. Rather than using a linear combination, we compute the objective functions separately and convert them to a single number by Pareto ranking (by default we use the Fonseca-Fleming variant²⁹). The Pareto rank serves as the final score on which filtering is based.

When Pareto ranking, we can (and by default do) set score constraints. This alters the way in which Pareto ranking operates. Normally, one solution will be awarded a better rank than another if, and only if, it scores better on all three scoring functions. When a score constraint is applied (e.g. V<900), an extra rule applies: for any pair of solutions, if one solution breaks a constraint (e.g. has V=901) and the other does not, the solution breaking the constraint is awarded the poorer rank. Score constraints can be specified in absolute or percentile terms. By default, we use the latter, setting the constraints V<30%, HB>70%. This means that an overlay must be in the best 30% of volume scores and the best 30% of hydrogen-bond scores to avoid breaking a constraint.

If the filtering algorithm needs to select between several solutions tied on the same rank, the solution is considered best that has the smallest value of Σrᵢ, the sum of the ranks of the individual objective scores (so-called Borda tallies). By default, we require all solutions with Pareto rank>5 to be rejected and limit the total number of selected solutions to 20. The overlay dissimilarity metric used for ensuring solution diversity is the consensus coefficient described later; solutions are rejected if their dissimilarity from any overlay already accepted is <0.05.

Overlay Refinement.

This has the purpose of improving an already good overlay (i.e. from the preceding steps) by bringing approximately aligned groups into tighter alignment. Refinement is achieved by simulated annealing, changing one chromosome torsion value (i.e. one acyclic torsion angle in one ligand) at each annealing step. Changed values must respect any torsion-angle constraints set by the user. The following cost function, F, seems to give robust results:

F=HB−0.5V+HY−0.3E

The initial annealing temperature is set to a low value, 0.01 times the F value of the starting overlay. This is because the initial overlay will already be good and the object is to achieve minor improvements rather than perform a wide exploration of overlay space. The temperature is reduced by 5% every N/40 steps, where N is the total number of steps (10,000 is usually ample). Annealing is usually successful at producing well-refined solutions, but it is slow. Alternative (e.g. faster) techniques for optimising the cost function are known to the skilled person.

Overlay Multiplication.

This aims to take a good overlay and investigate whether other alignments exist with the same mapping of features (i.e. the same clusters of fitting points) but different ligand conformations (therefore placing the clusters in different relative positions). This is a distinct possibility if the ligands are flexible and of practical concern if the aim is to produce a pharmacophore hypothesis for virtual screening. Ideally, all possible solutions should be found at the overlay generation stage, but only a limited number of solutions will normally be requested, and the diversity maximisation algorithm used during filtering may bias selection towards overlays expressing different feature mappings. FIG. 10 shows two overlays of dihydrofolate reductase ligands with identical feature mappings but different ligand conformations (and, therefore, leading to different pharmacophore queries).

The algorithm begins by constructing a chromosome mapping table that reflects all of the full and partial pharmacophore points in the starting overlay. A population of 150 chromosomes is set up (here and below, default parameters are quoted), each containing this mapping table but with randomised torsion-angle values. The population is subjected to 150 generations of MOGA optimisation. 150 children are produced in each generation by torsion mutations or crossovers, the former being three times more likely. Mutation involves a random change to one torsion value of a parent chromosome to produce the child. Mutated values must respect any torsion-angle constraints set by the user. Crossover takes two parents and swaps some of their torsion-angle values. The swap is restricted to torsion angles involving a single (randomly chosen) ligand. The result is two child chromosomes. Parents are chosen by tournament selection.

For each generation, parent and child populations are merged and Pareto ranked, using the objective functions V, HB, HY and E. Up to 150 chromosomes from the merged population are accepted for the next generation. Selection is based on Pareto ranks, coupled with niching to promote geometric diversity. A maximum of 50 niches is allowed, each containing no more than 3 members. Chromosomes are placed in the same niche if their dissimilarity is less than a set value and, once the niche is full, no other chromosome that would belong to it can be accepted for the next generation. For speed, dissimilarity is measured not by the coefficients described in the next section but by the following crude technique. A subset of atoms is chosen, including one from every feature of every ligand. For each overlay, the matrix of squared distances between the chosen atoms is calculated (including all pairs of atoms, whether from the same or different ligands). The dissimilarity of an overlay pair is then estimated by calculating the mean absolute difference between corresponding elements of their squared distance matrices.

Overlay Dissimilarity.

Two questions can be asked when comparing a pair of overlays of the same ligands. First, are the same ligand groups matched in each overlay (i.e. how different are the pharmacophores in terms of the number and types of pharmacophore points they contain, and the individual ligand fitting points that contribute to them)? Second, are the overlays similar geometrically? We therefore use three dissimilarity measures, one pharmacophore based, one based on geometry, and the third a consensus measure.

Pharmacophore Dissimilarity Coefficient.

The pharmacophore present in each of the overlays (A, B) to be compared is identified by cluster analysis of the ligand fitting points. All pairs of pharmacophore points, one from A and one from B, that are of the same type (donor, acceptor or hydrophobe) are examined. For a given pair, P_{A} and P_{B}, let N_{A} be the number of ligand fitting points “in” (i.e. contributing to) P_{A}, N_{B} be the number in P_{B}, and N_{AB} be the number that are in both P_{A} and P_{B}. The similarity of the pair is computed by the Tanimoto metric T=N_{AB}/(N_{A}+N_{B}−N_{AB}). The weight of the pair is defined as w=[(N_{A}+N_{B})/2]².

The optimum matching of pharmacophore points in A with those of B is then determined, first by matching the pair with the highest Tanimoto coefficient, then the pair with the next highest (excluding any pair involving a pharmacophore point that has already been matched), and so on, until no further matching is possible. Some pharmacophore points may be left unmatched. For these, the quantity U=ΣNᵢ² is calculated, where summation is over the unmatched pharmacophore points and Nᵢ is the number of ligand fitting points in the ith unmatched point. The pharmacophore dissimilarity coefficient, Dₚ, is then calculated as

Dₚ=1−ΣwᵢTᵢ/(U+Σwᵢ)

the summation being over the optimally matched pairs.

Geometric Dissimilarity Coefficient.

The geometric dissimilarity of overlays A and B is based on the RMSD of the least-squares best fit between non-hydrogen atoms in A and the corresponding atoms in B. Defining the atom correspondence is complicated if one or more of the ligands contains local topological symmetry, e.g. a carboxylate group. A two-step procedure is used. In step 1, each ligand in A is least-squares fitted onto the corresponding ligand in B, using all possible ways of matching the atoms (i.e. all possible matches of the ligand graph onto itself). The atom pairing giving the lowest RMSD is stored. In step 2, the entire overlay A is matched onto B, using the atom pairings stored for each ligand from step 1. The resulting RMSD is converted to a dissimilarity coefficient, D_{G}, in the range 0-1 (c.f. the GARD transformation³⁰), the effect of which is to set D_{G} to 0.0 for RSMD<0.5 Å, 1.0 for RMSD>3.5 Å, and (RMSD−0.5)/(3.5−0.5) for 0.5≦RMSD≦3.5 Å.

Consensus Dissimilarity Coefficient.

The consensus dissimilarity, D_{C}, is √(D_{P}D).

Analysis of Results.

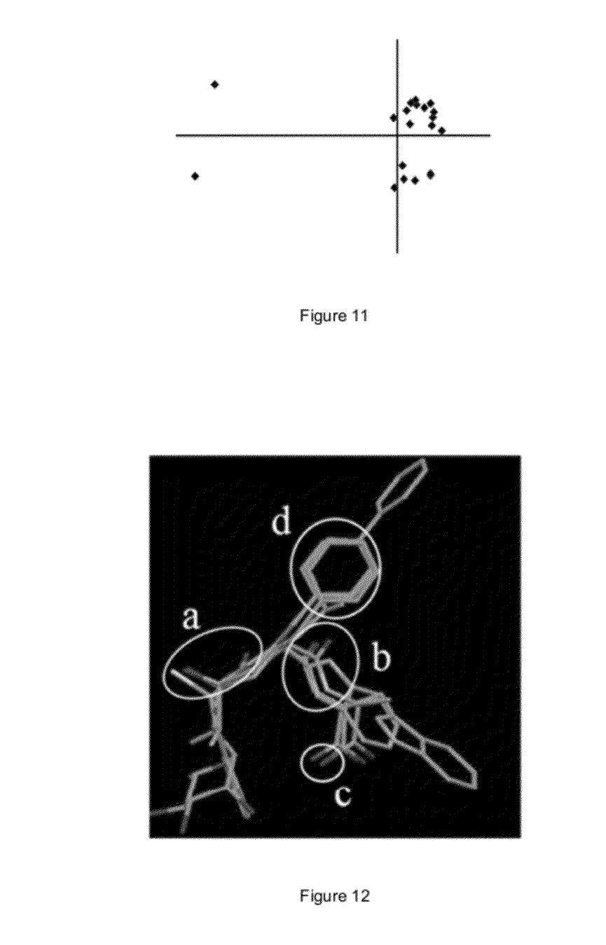

Any two solution overlays can be superimposed automatically to aid their comparison. Superposition is achieved either by least-squares fitting of atoms or of pharmacophores (using pharmacophore-point pairings derived from calculating the D_{P} coefficient). If the latter is used, the consensus pharmacophore of the two solutions is also calculated and displayed. To further aid comparison, multidimensional scaling (performed with the SMACOF algorithm³¹) is used to produce 2D or 3D maps of the final set of overlays, the intention being that similar overlays should lie close together on the map. Three separate maps are calculated, based on each of the dissimilarity coefficients described in the preceding section. Maps can be coloured on any of the objective scores. The maps can be very revealing. For example, FIG. 11 is a map of overlays of cycle checkpoint kinase ligands showing two distinct clusters of solutions and two outliers. However, overlays are complex objects and variations between them can be represented only approximately in a low dimensional map. Typically, up to 25% (33%) of the variation cannot be represented in a 3D (2D) map. Thus, while useful, the maps should not be over-interpreted. However, we prefer them to non-graphical cluster analysis.

### Results

Test Data.

The program was tested on ten series of protein-ligand complexes from the PDB (Table 1), and on some subsets of these series (Table 2). All complexes are members of the Astex Non-Native Set, which was compiled from well-refined structures with a bias towards proteins of therapeutic relevance.³² The complexes in each series were superimposed by least-squares fitting the binding-site atoms in Relibase+,³³ hence producing the true, crystallographically-observed overlay. Each complex was inspected to determine ligand protonation states and to identify all protein-ligand interactions. This enabled the true pharmacophore points to be identified and distinguished from incidental clusters of donors, acceptors and hydrophobes. Ligand models were created with CORINA³⁴ with addition of any required hydrogen atoms. Six sets of conformers were generated for all ligands. Three (RAW5000, RAW1000 and RAW200) were produced using the raw CORINA-generated molecules as input, with the maximum number of conformers per ligand set to 5000, 1000 and 200, respectively. The OMEGA rmsd and ewindow parameters were set to 0.5 Å and 10 kcal/mol, respectively; default values were used for all other parameters. The remaining conformer sets (OPT5000, OPT1000 and OPT200) were generated in similar fashion except that the CORINA models were subjected to geometry optimisation with the SZYBKI molecular mechanics program³⁵ before input to OMEGA. We noted that OMEGA gratuitously changed the bond types of a small number of chemical groupings (in particular, removing the formal charge on some aromatic nitrogens by making the ring non-aromatic) but felt the error was sufficiently unimportant that it could be ignored (a conservative decision, since sub-optimum bond types are likely to worsen rather than improve the validation results).

TABLE 1
Test series.

| | number of | |
|---|---|---|
| protein | complexes | PDB codes |
| protein kinase 5 (PfPK5) | 2 | 1v0o, 1v0p |
| fatty acid binding protein | 3 | 1tou, 1tow, 2hnx |
| (FABP) | | |
| neprilysin (NEP) | 4 | 1dmt, 1r1h, 1r1j, 1y8j |
| dihydrofolate reductase | 6 | 1drf. 1hfr, 1mvt, 1pd9, |
| (DHFR) | | 1s3v, 2dhf |
| cycle checkpoint kinase | 16 | 1nvq, 1nvr, 1nvs, 1zlt, 1zys, |
| (Chk1) | | 2br1, 2brb, 2brh, 2brm, 2bro, |
| | | 2c3l, 2cgu, 2cgw, 2cgx, 2hog |
| neuraminidase (NANase) | 11 | 1a4g, 1a4q, 1b9s, 1b9t, 1b9v, |
| | | 1inf, 1inv, 1ivb, 1nsc, 1nsd, |
| | | 1vcj |
| carbonic anhydrase (CA) | 13 | 1bn3, 1bn4, 1bnq, 1cim, 1eou, |
| | | 1if7, 1oq5, 1xpz, 1zgf, 1zh9, |
| | | 2eu3, 2hoc, 2nng |
| adenosine deaminase | 11 | 1krm, 1ndv, 1ndw, 1ndy, 1o5r, |
| (ADA) | | 1qxl, 1uml, 1v7a, 1v79, 1wxy, |
| | | 2e1w |
| heat shock protein (HSP) | 10 | 1byq, 1uy8, 1yc1, 1yc4, 1yet, |
| | | 2bsm, 2by1, 2bz5, 2cct, 2uwd |
| acetylcholinesterase | 11 | 1dx6, 1e66, 1eve, 1gpk, 1gpn, |
| (AChE) | | 1h23, 1w4l, 1zgb, 2ack, 2c5g, |
| | | 2ckm |

TABLE 2
Subsets of test series.

| protein/ | number of | |
|---|---|---|
| subset | complexes | PDB codes |
| ADA/1 | 10 | 1ndv, 1ndw, 1ndy, 1o5r, 1qxl, 1uml, 1v7a, |
| | | 1v79, 1wxy, 2e1w |
| ADA/2 | 4 | 1o5r, 1qxl, 1uml, 1wxy |
| ADA/3 | 4 | 1ndv, 1o5r, 1qxl, 1uml |
| HSP/1 | 7 | 1yc1, 1yc4, 2bsm, 2by1, 2bz5, 2cct, 2uwd |
| HSP/2 | 3 | 1byq, 1uy8, 2cct |
| AChE/1 | 9 | 1dx6, 1e66, 1gpk, 1gpn, 1h23, 1w4l, 1zgb, |
| | | 2ack, 2ckm |
| AChE/2 | 4 | 1h23, 1w4l, 1zgb, 2ckm |

Success Criteria.

Our choice of success criteria was driven by two considerations. Firstly, it cannot be assumed that the true overlay is the only (or most) convincing way in which the ligands can be aligned. It is possible that an incorrect solution may look “better” and such a solution should be presented to the user for consideration. Secondly, it is more important to correctly predict the feature mappings than the overall shape. An overlay with correct feature mappings is extremely useful, even if the ligand conformations are wrong, because: (a) it indicates which functional groups are critical to activity; (b) the pharmacophore query it suggests will probably find useful hits (since flexible active molecules in the search database may be able to adopt the required conformations); (c) it can serve as a starting point for overlay multiplication. Further, if there are parts of ligands that are not involved in binding, then it may be mere fluke if they are placed in the correct positions by the overlay program (for this reason, we eschew use of the all-atom root mean square deviation from the true overlay as a success measure). We therefore define success as generating an overlay with substantially correct feature mappings (preferably, but not necessarily, in their correct relative positions) in the small number of top-ranked solutions that a user is likely to view (we have assumed users will look at up to 20).

The pharmacophore points (both full and partial) in each true overlay were manually divided into groups. For example, FIG. 12 illustrates a true overlay of neprilysin (NEP) ligands and shows clusters a-d of pharmacophoric atoms. These clusters are: (A) the acceptor points representing the acidic atoms that coordinate the active-site zinc and hydrogen bond to His711 and Glu584; (B) the pair of donor and acceptor points representing amide and imidazo groups that hydrogen bond to Asn542 and Arg717; (C) the acceptor point corresponding to carboxylate oxygen atoms that hydrogen bond to Asn542.; (D) the hydrophobic point representing phenyl and isobutyl groups that interact with Val580, Trp693, etc. Each pharmacophore-point group was classified as being of major, moderate or minor importance, depending on whether it contains full pharmacophore points, or partial points involving many or few ligands. Table 3 summarises the pharmacophore-point groups for the NEP ligands. Analogous analyses were performed for the other test series.

TABLE 3
Pharmacophore-point groups for the NEP ligands.

| group | description | full^{a} | partial^{b} | importance |
|---|---|---|---|---|
| A | acidic groups (including | 1 | 1 | major |
| | thiolates) binding Zn, | | | |
| | accepting from E584, H711 | | | |
| B | amide and imidazo groups | 2 | 0 | major |
| | donating to N542, | | | |
| | accepting from R717 | | | |
| C | carboxylate oxygens | 0 | 1 | moderate |
| | accepting from N542 | | | |
| D | phenyl and isobutyl | 1 | 0 | major |
| | groups making hydrophobic | | | |
| | contacts in vicinity of | | | |
| | V580, H583 and W693. | | | |

^{a}Number of full pharmacophore points in group.
^{b}Number of partial pharmacophore points in group.

We then identified the atoms (donors, acceptors and dummy atoms at the centroids of hydrophobic groups) that constituted the pharmacophore points in each group (for example, the carboxylate oxygens constituting group C of the NEP ligands). For any given predicted overlay, we calculated the quantities Rᵢ, i=1, 2, . . . N, where N is the number of pharmacophore-point groups and Rᵢ is the root mean square deviation (rmsd) obtained when the atoms constituting the pharmacophore points of the ith group in the true overlay are least-squares fitted onto the corresponding atoms in the predicted overlay. We also calculated Rₜₒₜₐₗ, the rmsd obtained when all atoms of the true overlay that were included in any Rᵢ calculation are least-squares fitted onto the corresponding atoms of the prediction. If all Rᵢ are small, the predicted overlay contains all the correct pharmacophore points but not necessarily in their correct relative positions (i.e. correct feature mappings, but possibly incorrect ligand conformations). If the Rᵢ and Rₜₒₜₐₗ are small, the predicted overlay contains the correct pharmacophore points in or close to their correct relative positions. In addition to these objective measures, we also assessed solutions subjectively, e.g. by superimposing solutions on the true overlay and manually looking for badly misplaced ligands.

Test Results.

Using the conformer set RAW5000, the program was used to produce a set of no more than 20 solutions for each test series, including the subsets in Table 2. No overlay refinement or multiplication was performed unless otherwise stated in the discussion below. The solutions in each set were ranked from 1 to 20, based on their Pareto ranks in (V, HB, HY) space, and, in the event of ties, on their Borda tallies. Each solution was characterised by its Rᵢ and Rₜₒₜₐₗ values and many were manually inspected. Table 4 summarises the results. The Rᵢ and Rₜₒₜₐₗ values (in Å) pertain to the solution that appeared to us to best represent the true overlay (a somewhat subjective judgment). Successive Rᵢ values on each line correspond to the various pharmacophore-point groups in each true overlay, and are separated into those that represent groups of major, moderate and minor importance. The number of badly misplaced ligands (if any) in the solution is given, together with the rank of the solution (column headed “rank, best”). The table also shows the rank of the highest-ranked solution that had substantially correct feature mappings (“rank, highest”). For some series (listed at the foot of the table), it was considered that all solutions were seriously flawed; Rᵢ and Rₜₒₜₐₗ values are not given in these cases.

TABLE 4
Results obtained from RAW5000 conformers.^{a}

| | Ri | Ri | Ri | | badly | rank, | rank, |
|---|---|---|---|---|---|---|---|
| series | (major) | (moderate) | (minor) | Rtotal | misplaced | best | highest |
| PfPK5 | 0.6 | — | — | 0.6 | 0 | 2 | 1 |
| FABP | 0.3, 0.6, 1.5, 1.7 | — | — | 1.5 | 0 | 5 | 1 |
| NEP | 1.6, 0.4, 0.5 | 0.4 | — | 1.2 | 0 | 2 | 1 |
| DHFR | 0.4, 1.3 | — | 0.2, 0.2 | 2.0 | 0 | 2 | 2 |
| Chk1 | 0.5 | 1.2, 1.0 | 0.3, 2.1 | 1.2 | 0 | 1 | 1 |
| NANase | 0.7, 0.3 | 0.4 | 0.9, 0.6, 0.9 | 0.8 | 1 | 4 | 1 |
| CA | 1.3, 0.5 | 1.6, 1.6 | 1.4 | 1.8 | 2 | 4 | 4 |
| ADA/1^{b} | | 0.7, 0.5, 0.3, | 1.9 | 1.3 | 0 | 1 | 1 |
| | | 0.7, 1.1 | | | | | |
| ADA/2 | 0.9, 0.7, 0.2, 1.3 | 0.2, 0.2 | — | 1.9 | 0 | 18 | 1 |
| ADA/3 | 0.9, 0.8, 0.7, 1.7 | 0.1, 0.2 | — | 2.5 | 0 | 3 | 3 |
| HSP/1 | 0.5, 0.7, 0.2 | 0.2, 0.2, 0.9 | 0.2 | 1.0 | 0 | 5 | 1 |

^{a}No correct solutions were obtained for: ADA, HSP, HSP/2; AChE, AChE/1, AChE/2.
^{b}Obtained by stepwise method.

### DISCUSSION

Most of this section contains an analysis of the results from the RAW5000 conformer set. The effect of using other conformer sets is discussed briefly at the end of the section.

Protein Kinase 5, PfPK5.

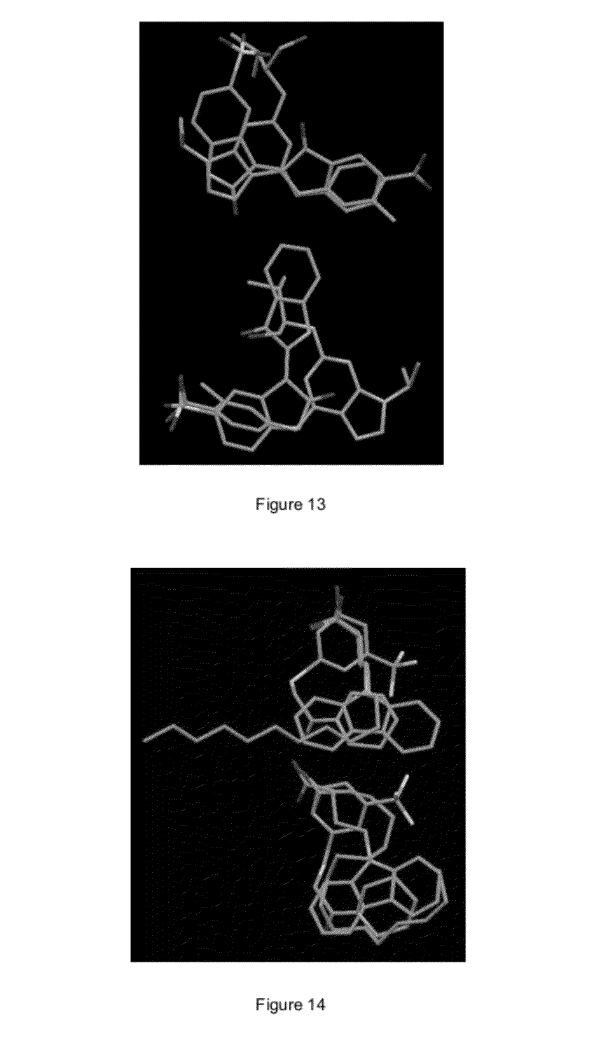

The main problem with this otherwise simple series is that both ligands contain acid groups, and we might expect the algorithm to produce overlays in which these groups are superimposed. However, this is incorrect: the acid groups are widely separated in the true overlay, neither forming any significant interactions with the protein. Ideally, the program should generate both the correct solution and the obvious but incorrect alternative. This is achieved. Only nine solutions survive the filtering, of which six are closely related and similar to the true overlay, while the other three have the acid groups superimposed. FIG. 13 shows two of the predictions, the top one being similar to the true overlay, and the bottom one being a credible alternative with ligand acid groups overlaid. The occurrence of clusters of similar solutions in the filtered output is a consequence of using a low filtering dissimilarity threshold (0.05), which may not be the optimum choice.

Fatty Acid Binding Protein, FABP.

This is a very simple series, the only challenge being to find the folded conformation of the C15 chain of the 2hnx ligand that allows it to fit into the binding site, and that places it within the envelope of the other two ligands. In fact, this is not very well achieved in the overlay generation step, which tends to produce solutions like that shown at the top of FIG. 14 (solutions from the OPT5000 conformer set tend to be better). However, refinement by annealing readily fixes the problem (FIG. 14, bottom). For the top-ranked solution, refinement reduces an initial overlay volume of 451 Å³ to 363 Å³, marginally lower than that of the true overlay. A minor but understandable error in the hydrogen-bond matching is that the carboxylate oxygens of the 2hnx and stow ligands are invariably matched onto both the hydroxyloxygen and one of the pyrimidine nitrogens of the 1tou ligand. In fact, only the hydroxyl oxygen of the latter ligand appears to hydrogen bond to the protein. It is not uncommon for the algorithm to find better matching of hydrogen-bond groups than occurs in reality and, in many cases, there seems no way of predicting that the less convincing matching is actually correct.

Neprilysin, NEP.

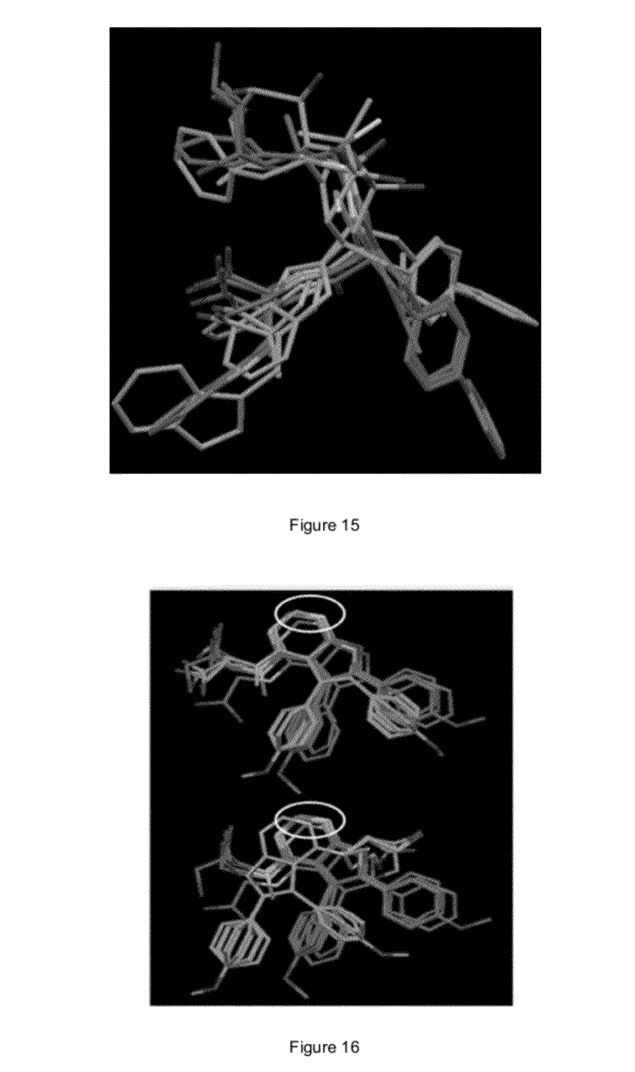

This series is quite difficult because, although it contains only four ligands, they are flexible and feature rich. Nevertheless, the solutions are excellent. Eight of the top ten solutions have essentially correct feature mappings, though several involve different ligand conformations from those seen in the crystal structure. There are invariably some minor errors in the vicinity of the metal-binding ligand groups but never sufficient to obscure the probable significance to binding of these groups. As shown in FIG. 15, the second-ranked solution (carbons coloured green) has both correct mappings and conformations. Solution 9 is a different but very credible overlay in which the thiolate of the 1y8j ligand is matched with carboxylate oxygens from the other ligands. Only a small minority of the top twenty solutions look unconvincing.

The 1r1j and 1y8j ligands in this series were built in their thiolate forms, since it was known that the sulfur atoms coordinate zinc and are therefore likely to be ionised. No solutions were generated from the unionised forms but they would probably have been much poorer. In a genuine drug invention project, the quality of answers would therefore depend on whether investigators were aware of the probable presence of a zinc ion in the binding site of the target protein.

Dihydrofolate Reductase, DHFR.

Results on this series are very good. The critical requirement is to generate the correct alignment of heterocycles, in which some of the bicyclic systems are flipped in order to maximise overlap of donors on donors and acceptors on acceptors. The correct heterocycle alignment is present in about half of the solutions that survived filtering. Most of the remaining solutions contain plausible alternative alignments. The highest ranked solution with the correct heterocycle alignment (solution 2) also has the amide and carboxylate groups of the 1drf, 1 hfr and 2dhf ligands correctly superimposed and all six phenyl rings in roughly the same position. In the true overlay, there is a distinct separation between the phenyl groups of the 1drf, 1 hfr and 2dhf ligands and those of the remaining ligands, but it is not clear how this could be predicted.

Although solution 2 has almost perfect feature matching, it involves incorrect ligand conformations (extended rather than bent). This is a typical result for this series: prediction of the correct feature matching is easily achieved but almost always with extended conformations. Only the OPT5000 conformer set can generate solutions with ligand conformations similar to those seen in the crystal structures. However, the problem is solved by overlay multiplication. To demonstrate this, solution 2 was subjected to this process. Both bent and extended overlays with correct feature matchings were produced. FIG. 10 shows the original solution 2 (top) and the top-ranked solution from overlay multiplication, after annealing (bottom); the latter is close to the true overlay in both feature matching and ligand conformations.

Cycle Checkpoint Kinase, Chk1.

Although this series contains six very similar ligands (2br1, 2brb, 2brg, 2brh, 2brm, 2bro), it is otherwise quite diverse. Results are excellent. Most of the solutions are close to the true overlay and, in particular, the key pair of donor and acceptor pharmacophore points is found with, in each case, all the correct donors and acceptors from the individual ligands. It is to this series that the map shown in FIG. 11 pertains. The two large clusters on the right of this map comprise essentially correct solutions, the difference between them being that one of the ligands (1zys) is rotated by about 30° in one cluster compared to the other. The two outliers on the left of the map correspond to a different and incorrect positioning of the six similar ligands referred to above. In both correct and outlier solutions, the CH groups at the 2-position of the fused pyrimidine rings of the 2br1 . . . 2bro ligands are correctly placed in the key donor cluster but, in the outliers, these six ligands are all flipped so that the wrong pyrimidine nitrogen is placed in the key acceptor cluster. FIG. 16 shows, at top, the true overlay of the ligands from the cycle checkpoint kinase complexes 2br1, 2brb, 2brg, 2brh, 2brm, 2bro (carbons in purple) superimposed on the corresponding ligands from one of the correct solutions obtained for the Chk1 test series. (carbons in green, remaining ligands in series omitted for clarity), and, at bottom, the same true overlay superimposed on ligands 2br1 . . . 2bro from one of the incorrect outlier solutions. Both have the requisite cluster of donor and acceptor atoms (circled) but the acceptor cluster in the incorrect solution involves the wrong pyrimidine nitrogen. In addition, one of the outliers also has another ligand (1zlt) flipped in a somewhat similar manner, resulting in a chemically reasonable but incorrect matching. While the multidimensional-scaling maps are not always useful, they can, as in this case, highlight differences between overlays that might easily be missed by anything less than a thorough manual inspection.

Neuraminidase, NANase.

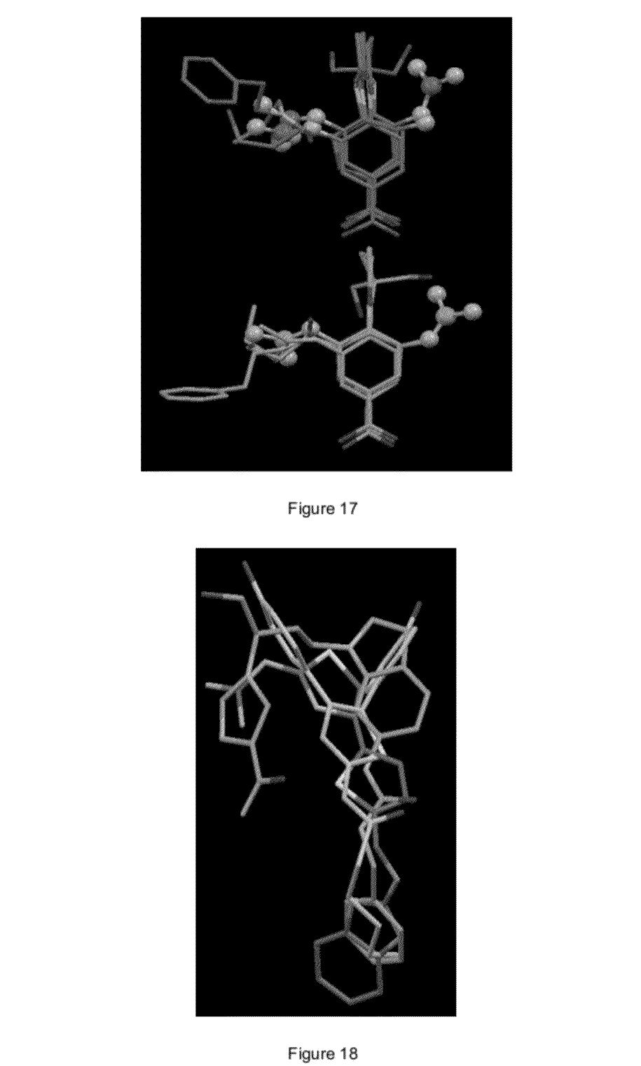

This is a series of very similar ligands, all containing a core substructure comprising a 6-membered ring with para-related acid and amide (or lactam) substituents. It was included in the test set to mimic the type of series that might be overlaid in a 3D QSAR exercise. Although the problem may appear trivial, it is not. Accepting that the core substructures from the eleven ligands should be overlaid on one another, there are still many ways of achieving this. Given that the torsion angle between the 6-membered ring and the amide or lactam group can be rotated, if the first ligand is placed arbitrarily, the second and subsequent ligands may each be superimposed on the first ligand in two ways whilst keeping the core substructures exactly aligned, giving a total of 2¹⁰ possibilities for the complete overlay. With this in mind, we were surprised to find that several of the solutions, including the top-ranked, have each molecule “the right way round”. This is particularly impressive as it places two cationic (guanidinium) groups on one side of the overlay and two (a guanidinium and ammonium) on the other, a correct but perhaps surprising arrangement. FIG. 17 shows, at top, the true overlay of four of the neuraminidase ligands (1a4g, 1a4q, 1b9t, 1inf), and, at bottom, the positions of the same ligands in the best predicted overlay (remaining ligands in series omitted for clarity). In both, two cationic groups (shown in ball-and-stick style) lie on one side of the overlay and two on the other. Since this solution is found several times, it cannot be ascribed to luck. The probable explanation is that the correct overlay has a very low union volume, and therefore survives the filtering step.

The ligand from 1nsc cannot be placed optimally because OMEGA does not generate the rather strained ring conformation reported in the PDB structure. Instead, it generates chair conformers with the carboxylate group axial, meaning that that this group cannot be superimposed on the acid groups of the other ligands. This problem is found with all the conformer sets.

Carbonic Anhydrase, CA.

This series of ligands all contain sulfonamide or sulfamate groups that coordinate the active-site zinc atom. Although the Rᵢ and Rₜₒₜₐₗ values for the best solution look reasonable (Table 4), it is not a particularly good prediction. The metal-coordinating warheads are correctly overlaid (this is true in all solutions) and there is enough of a cluster of acceptors to indicate the presence of the partial pharmacophore point corresponding to interaction with Gln92. The hydrophobic side chains of the 1bn3, 1bn3, 1bnq, 1if7, 1oq5, 1xpz, 1zh9 and 2hoc ligands are overlaid about as well as in the true overlay (which is to say, not very), but in the wrong position (i.e. the ligand conformations are different from those in the true overlay). The 2eu3 ligand is badly misplaced (this is invariably the case in all solutions). Overall, the predictions for this series, while containing some of the characteristics of the true overlay, add nothing to what is likely to be discerned by a competent modeler (in contrast to the neuraminidase series, where we feel the program genuinely adds value). Annealing the solutions arguably improves the situation somewhat. We have no insight into why the algorithm finds this series comparatively difficult, save to note that the peripheral hydrophobic groups in the true overlay (i.e. those remote from the warhead groups) are not tightly-overlaid.

Adenosine Deaminase, ADA.

This is perhaps the most interesting ligand set. The correct solution is not found for the complete series. An obvious reason is that the ligand from the 1krm complex adopts a binding mode that is drastically different from those of the other ligands. When this ligand is omitted (i.e. subset ADA/1), correct solutions are still not generated by the standard approach. All but two of the molecules in this subset are chemically similar imidazoliums, and these are overlaid with ease, but the correct positioning of the other two ligands (1ndv and 1wxy) remains elusive. The problem is that the true overlay of the 1ndv and 1wxy ligands on any of the imidazoliums—the 1o5r ligand, for example—does not contain a common pharmacophore of size FIG. 18 shows the true overlay of three adenosine deaminase ligands from PDB complexes 1o5r, 1ndv and 1wxy (carbon atoms coloured in green, purple and orange, respectively). No protein residue hydrogen bonds to all three ligands, and the overlap of hydrophobic groups is insufficient to generate a common pharmacophore triplet, at least with our placement of hydrophobic fitting points. Thus, no base triplet exists from which an alignment fingerprint can be built to generate the correct answer. In support of this hypothesis, the algorithm does find solutions acceptably close to the true overlay for subsets comprising three of the larger imidazoliums and one or other (but not both) of the 1ndv and 1wxy ligands, for which subsets (ADA/2 and ADA/3) a common pharmacophore of size 3 clearly exists in the true overlays.

However, we were successful in generating the correct overlay for ADA/1 by the stepwise approach. In our first experiment, the imidazoliums were overlaid without the 1ndv and 1wxy ligands. The top 20 solutions were treated as “conformers” of a “supermolecule” and used as input to a second overlay-generation job in which the 1ndv ligand was introduced. Finally, a third step was used to generate overlays involving the 1wxy ligand. Results were excellent. Three other ordering strategies that we thought might work were also tried. All produced at least one solution acceptably close to the true alignment. The results in Table 4 were obtained by pooling the solutions from the four separate stepwise experiments and re-ranking.

Heat Shock Protein, HSP.

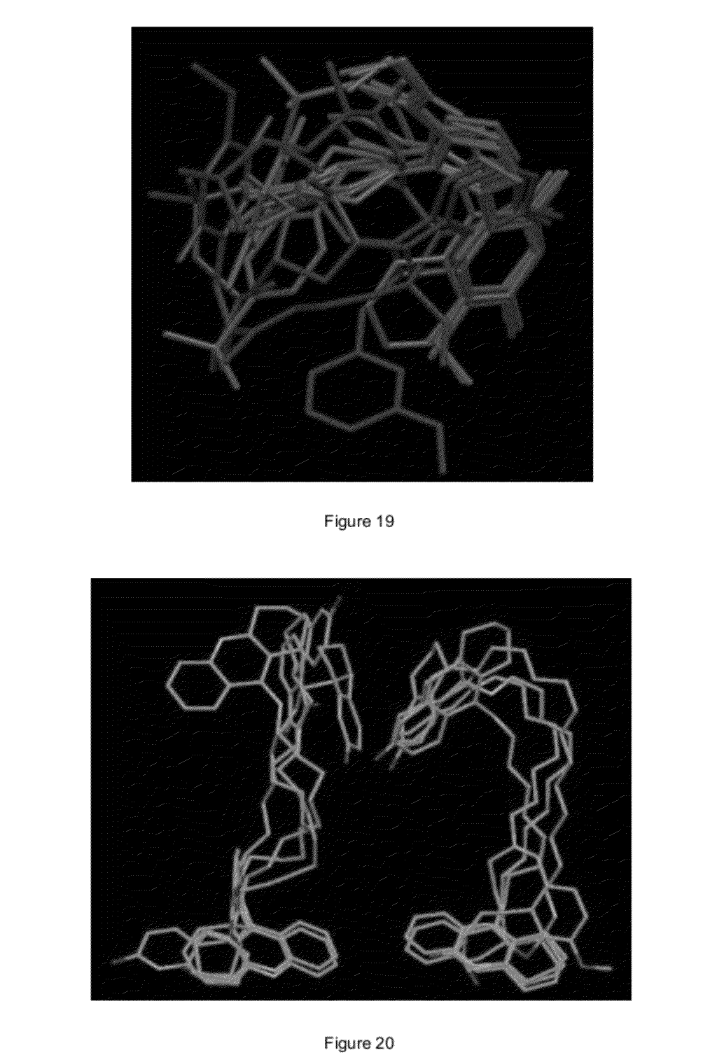

The ten ligands in this series may be divided into two groups: (a) the closely similar pyrazole or isoxazole ligands of 1yc4, 2byi, 2cct, 1yc1, 2bsm, 2uwd, together with the structurally unrelated ligand from 2bz5; and (b) two purine ligands (1byq and 1uy8) and the macrocyclic ligand from 1yet. All the ligands donate to Asp93 and accept from Thr184 and/or a conserved water molecule. However, the donor (D) and acceptor (A) groups in the group b ligands have shorter D . . . A distances than in the ligands of group a, potentially making the results sensitive to the choice of triplet distance bins. More seriously, the binding cavity has a rather large opening and the ligands from the two groups occupy different parts of it. FIG. 19 shows the true overlay of the ten heat shock protein ligands, showing the poor volume overlap of three ligands (from PDB complexes 1byq, 1uy8, 1yet, coloured in purple) with the remainder (1yc1, 1yc4, 2bsm, 2byi, 2bz5, 2cct, 2uwd, coloured in green). Consequently, reasonable results are obtained for subset HSP/1 (containing all the ligands in group a, but none from group b) but not for the complete series of all ten ligands, or for subsets such as HSP/2 which involve ligands from both groups. An additional problem with the HSP/2 subset is that many of the false solutions score better than the true overlay (e.g. have far lower union volumes and better matching of hydrogen-bonding groups). Thus, it is not clear how the true overlay could be recognised as such even if it could be generated by the algorithm. We conclude that this is a very difficult test series.

Acetylcholinesterase, AChE.

This is the only protein on which we are entirely unsuccessful. No overlays at all (not even incorrect ones) can be generated for the complete series of eleven ligands because the algorithm cannot find any base triplet from which to construct an alignment fingerprint. The smallest ligand (2c5g) and the ligand from 1eve must be omitted before any solutions can be produced (AChE/1), but nothing close to the true answer is found. The exceptional difficulty of the series may be ascribed to the following reasons. (a) Protein-ligand binding is almost entirely hydrophobic in nature. Thus, no protein atom forms hydrogen bonds to more than three of the eleven ligands; several ligands form only one hydrogen bond to the protein; and one (1eve) forms no hydrogen bonds at all. Since hydrophobic interactions are much less directional than hydrogen bonds, this makes overlay prediction a far harder task. Further, several of the ligands have donor groups, so the algorithm tends to find false solutions with partial donor pharmacophore points. (b) The true overlay is in some respects less convincing than some of the solutions produced by the algorithm. For example, FIG. 20 shows the true (left) and a predicted (right) overlay for the subset of large ligands, AChE/2. In the true overlay, the heterocyclic systems in the vicinity of the AChE “peripheral binding site” (Trp279 and nearby residues) are much less closely overlaid that in the prediction. (c) There are significant ligand-induced conformational changes to the protein (specifically, at Phe330), altering the space accessible to ligands.

Perhaps the biggest problem is that binding to AChE seems to be dominated by “cation-pi” interactions, i.e. electrostatic attraction between the electron-rich Trp84 side chain and hydrophobic groups on the ligands that are rendered electron deficient by the inductive effect of nearby positive centres (all ligands in the series are cations). This type of electropositive hydrophobe is not specifically represented in our feature-typing scheme. Possibly, the series may be more amenable to field-based overlay methods.³⁶

Influence of Conformer Input; Computational Requirements.

Results obtained from the other conformer sets were inspected in sufficient detail to enable qualitative conclusions to be drawn, as follows. Although there seems to be a gradual improvement in results as the number of conformers is increased, the effect is small. For example, the RAW200 set yields results for PfPK5, FABP, NEP, DHFR and Chk1 that are of are comparable quality to those obtained with the RAW5000 set, while the overlays for NANase are very nearly as good. Computation times decrease dramatically for some series as the number of conformers is reduced (Table 5). Memory requirements, which can be substantial (over a gigabyte in some cases), are also appreciably reduced by decreasing the number of input conformers. We tentatively conclude that the faster turn round obtainable by using the smaller conformer sets may generally outweigh any consequential loss in solution quality, which will probably be small.

TABLE 5
Computation times (minutes) as a function of maximum number
of conformers per ligand (based on RAW conformer sets).^{a}

| | maximum number of conformers per ligand | | |
|---|---|---|---|
| series | 5000 | 1000 | 200 |
| PfPK5 | 0.7 | 0.7 | 0.6 |
| FABP | 0.5 | 0.5 | 0.3 |
| NEP | 38.4 | 19.8 | 4.2 |
| DHFR | 17.5 | 11.0 | 3.5 |
| Chk1 | 2.8 | 2.6 | 1.8 |
| NANase | 3.6 | 3.6 | 3.4 |
| CA | 4.9 | 4.8 | 2.7 |
| ADA | 52.2 | 16.2 | 5.4 |
| HSP | 21.1 | 11.0 | 5.0 |
| AChE/1 | 3.9 | 1.7 | 0.7 |

^{a}Elapsed times for overlay generation and filtering on an Intel T7500 2.2 GHz processor, excluding time required for conformer generation but including solution analysis (multidimensional scaling, etc.).

Optimising the geometry of the molecular models from which OMEGA generates conformers has variable effects. For DHFR, it is advantageous, since the geometry optimisation allows solutions to be found that have correct feature mappings, and ligand conformations similar to those seen in the true overlay. In contrast, solutions generated from unoptimised starting points often have correct feature mappings but invariably with incorrect ligand conformations (although this problem can be addressed by overlay multiplication, see above). For NANase, however, optimisation was counter-productive since it produced a poor geometry for the ligand from 1vcj, making it difficult to place correctly in the overlays. Overall, there is insufficient evidence at present to conclude that optimisation is worthwhile.

### CONCLUSIONS

The method described above generates overlays by logical operations on rows of an alignment fingerprint. Although fingerprints are used in other pharmacophore elucidation methods (e.g. ref. 7), each bit usually represents the presence or absence in a given molecular conformation of a pair of chemical groups of given types (i.e. “features”, in our nomenclature) separated by a distance falling in a particular range. The bits in our fingerprint are set on or off according to the presence or absence of a particular type of group (feature) at or near to a particular position in Cartesian coordinate space, when conformers are aligned in a consistent frame of reference defined by the positions of the points of a triplet pharmacophore known to be present in all the conformers. This method has several useful characteristics. Every overlay generated is guaranteed to have at least three full pharmacophore points, corresponding to the base triplet. The method takes into account partial as well as full pharmacophore points and is sensitive to whether two features in different molecules are exactly aligned (i.e. map to the same grid point) or only closely aligned (map to adjacent grid points). The B score calculated from the fingerprint correlates reasonably well with our more accurate hydrogen bond and volume scores, but is very quick to compute, allowing a very large number of trial conformer combinations to be tested.

The validation results show a clear pattern. The algorithm performs well on a given set of ligands if the true overlay contains at least three full pharmacophore points. Thus, good results are obtained for the test series PfPK5, FABP, NEP, DHFR, Chk1, NANase, ADA/2 and ADA/3: a high-ranking solution with the correct feature mappings and ligand conformations close to those seen in the PDB structures is almost always found. Results for CA (where the true overlay has the requisite 3 full pharmacophore points) are less good: the major features of the true overlay are reproduced adequately but minor details are not reliably reproduced. For DHFR, solutions with correct feature mappings are easily found but tend to have incorrect ligand conformations. However, overlay multiplication is effective on this series, i.e. finds alternative overlays with the same mappings but different conformations, including conformations similar to those in the crystal structures. (We suggest that multiplication should routinely be used to explore the geometric variability of pharmacophores prior to the construction of pharmacophore queries for virtual screening.) Occasionally, refinement of the overlays by simulated annealing produces significant improvements (e.g. brings hydrophobic groups closer together in the FABP series) but it is often unnecessary. Mapping of solution sets by multidimensional scaling gives helpful insights, e.g. for Chk1.

When the true overlay of a set of ligands does not contain three full pharmacophore points, the algorithm often performs poorly. In many cases, this is understandable. For example, the binding of the 1krm ligand in the ADA series is so different from that of the other ligands that it seems to present an intractable problem. Similar situations occur in HSP with the 1byq, 1uy8 and 1yet ligands, and in AChE, where the binding of the 1eve ligand is idiosyncratic. A variant of the problem is when the true overlay is simply not as convincing as false solutions (e.g. HSP/2, AChE/2) and is therefore likely to be overlooked by users even if generated. We suggest that prediction of the correct overlays in these difficult cases may well be impossible.

ADA/1 is an especially interesting case because the true overlay looks reasonably convincing but does not have three full pharmacophore points. The correct solution can be obtained by means of a stepwise approach. This is an important proof of concept since it significantly extends the range of problems on which our algorithm might be successful. A limitation of the stepwise approach is that a decision must be made on the order in which the overlay is pieced together. This is probably not as hard as it sounds because it may often be evident which ligands are causing difficulty, and the simple strategy of leaving these ligands to the end of the stepwise process may be successful, as it was for ADA/1.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable storage” as used herein refers to any tangible storage that participates in providing instructions to a processor for execution. Such storage may take many forms, including but not limited to, non-volatile storage, volatile storage, and transmission storage. Non-volatile storage includes, for example, NVRAM, or magnetic or optical disks. Volatile storage includes dynamic memory, such as main memory. Common forms of computer-readable storage include, for example, a floppy disk, a flexible disk, hard disk, magnetic tape, or any other magnetic storage, magneto-optical storage, a CD-ROM, any other optical storage, punch cards, paper tape, any other physical storage with patterns of holes, a RAM, a PROM, and EPROM, a FLASH-EPROM, a solid state storage like a memory card, any other memory chip or cartridge, or any other storage from which a computer can read. When the computer-readable storage is configured as a database, it is to be understood that the database may be any type of database, such as relational, hierarchical, object-oriented, and/or the like. Accordingly, the disclosure is considered to include a tangible storage and prior art-recognized equivalents and successor storage, in which the software implementations of the present disclosure are stored.

The terms “determine”, “calculate”, and “compute,” and variations thereof, as used herein, are used interchangeably and include any type of methodology, process, mathematical operation or technique.

Furthermore, in the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU) or logic circuits programmed with the instructions to perform the methods (FPGA). These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

### Acknowledgements

The inventor acknowledges the contributions of Professor Valerie Gillet and Dr Eleanor Gardiner (University of Sheffield), Dr David Cosgrove (AstraZeneca plc) and Dr Jason Cole (CambridgeCrystallographic Data Centre) to work described in the section “Detailed Description and Further Optional Features of the Invention”.

### REFERENCES

References 1 to 19, 21 to 24, 26 to 30, 32 to 34 and 36 referred to herein are incorporated by reference.
1. Leach, A. R.; Gillet, V. J.; Lewis, R. A.; Taylor, R. Three-Dimensional Pharmacophore Methods in Drug Discovery. J. Med. Chem. 2010, 53, 539-558.
2. Verma, J.; Khedkar, V. M.; Coutinho, E. C. 3D-QSAR in Drug Design—A Review. Curr. Top. Med. Chem. 2010, 10, 95-115.
3. Labute, P.; William, C.; Feher, M.; Sourial, E.; Schmidt, J. M. Flexible Alignment of Small Molecules. J. Med. Chem. 2001, 44, 1483-1490.
4. Dixon, S. L.; Smondyrev, A. M.; Knoll, E. H.; Rao, S, N.; Shaw, D. E.; Friesner, R. A. PHASE: a new engine for pharmacophore perception, 3D QSAR model development, and 3D database screening: 1. Methodology and preliminary results. J. Comput.-Aided Mol. Des. 2006, 20, 647-671.
5. Richmond, N. J.; Abrams, C. A.; Wolohan, P. R. N.; Abrahamian, E.; Willett, P.; Clark, R. D., GALAHAD: 1. Pharmacophore identification by hypermolecular alignment of ligands in 3D. J. Comput.-Aided Mol. Des. 2006, 20, 567-587.
6. Cho, S. J.; Sun, Y. FLAME: A Program to Flexibly Align Molecules. J. Chem. Inf. Model. 2006, 46, 298-306.
7. Feng, J.; Sanil, A.; Young, S. S. PharmID: Pharmacophore Identification Using Gibbs Sampling. J. Chem. Inf. Model. 2006, 46, 1352-1359.
8. Wolber, G.; Dornhofer, A. A.; Langer, T. Efficient overlay of small organic molecules using 3D pharmacophores. J. Comput.-Aided Mol. Des. 2006, 20, 773-788.
9. Todorov, N. P.; Alberts, I. L.; de Esch, I. J. P.; Dean, P. M. QUASI: A Novel Method for Simultaneous Superposition of Multiple Flexible Ligands and Virtual Screening Using Partial Similarity. J. Chem. Inf. Model. 2007, 47, 1007-1020.
10. Zhu, F.; Agrafiotis, D. K. Recursive Distance Partitioning Algorithm for Common Pharmacophore Identification. J. Chem. Inf. Model. 2007, 47, 1619-1625.
11. Marialke, J.; Koerner, R.; Tietze, S.; Apostolakis, J. Graph-Based Molecular Alignment (GMA). J. Chem. Inf. Model. 2007, 47, 591-601.
12. Anghelescu, A. V.; DeLisle, R. K.; Lowrie, J. F.; Klon, A. E.; Xie, X.; Diller, D. J. Technique for Generating Three-Dimensional Alignments of Multiple Ligands from One-Dimensional Alignments. J. Chem. Inf. Model. 2008, 48, 1041-1054.
13. Schneidman-Duhovny, D.; Dror, O.; Inbar, Y.; Nussinov, R.; Wolfson, H. J. Deterministic Pharmacophore Detection via Multiple Flexible Alignment of Drug-Like Molecules. J. Comput. Biol. 2008, 15, 737-754.
14. Taminaua, J.; Thijsa, G.; De Winter, H. Pharao: Pharmacophore alignment and optimization. J. Mol. Graph. Model. 2008, 27, 161-169.
15. Jones, G. GAPE: An Improved Genetic Algorithm for Pharmacophore Identification. J. Chem. Inf. Model. 2010, 50, 2001-2018.
16. Korb, O.; Monecke, P.; Hessler, G.; Stutzle, T.; Exner, T. E. pharmACOphore: Multiple Flexible Ligand Alignment Based on Ant Colony Optimization. J. Chem. Inf. Model. 2010, 50, 1660-1681.
17. Cottrell, S. J.; Gillet, V. J.; Taylor, R.; Wilton, D. J. Generation of multiple pharmacophore hypotheses using multiobjective optimisation techniques. J. Comput.-Aided Mol. Des. 2004, 18, 665-682.
18. Cottrell, S. J.; Gillet, V. J.; Taylor, R., Incorporating partial matches within multiobjective pharmacophore identification. J. Comput.-Aided Mol. Des. 2006, 20, 735-749.
19. Gardiner, E.; Cosgrove, D. A.; Taylor, R.; Gillet, V. J. Multiobjective Optimisation of Pharmacophore Hypotheses: Bias Towards Low-Energy Conformations. J. Chem. Inf. Model. 2009, 49, 2761-2773.
20. Deb, K. Multi-Objective Optimization using Evolutionary Algorithms. Wiley, Chichester, UK, 2001.
21. Berman, H. M.; Westbrook, J.; Feng, Z.; Gilliland, G.; Bhat, T. N.; Weissig, H.; Shindyalov, I. H.; Bourne, P. E. The Protein Databank. Nucleic Acids Res. 2000, 28, 235-247.
22. Hawkins, P. C. D.; Skillman, A. G.; Warren, G. L.; Ellingson, B. A.; Stahl, M. T. Conformer Generation with OMEGA: Algorithm and Validation Using High Quality Structures from the Protein Databank and Cambridge Structural Database. J. Chem. Inf. Model. 2010, 50, 572-584.
23. Cole, J. C.; Taylor, R.; Verdonk, M. L. Directional Preferences of Intermolecular Contacts to Hydrophobic Groups. Acta Crystallogr., Sect. D: Biol. Crystallogr. 1998, 54, 1183-1193.
24. Wolber, G.; Seidel, T.; Bendix, F.; Langer, T. Molecule-pharmacophore superpositioning and pattern matching in computational drug design. Drug Discovery Today 2008, 13, 23-29.
25. SMARTS—Language for Describing Molecular Patterns, Daylight Chemical Information Systems, Inc., Aliso Viejo, Calif., USA. www.daylight.com.
26. Taylor, R. Simulation Analysis of Experimental Design Strategies for Screening Random Compounds as Potential New Drugs and Agrochemicals. J. Chem. Inf. Comp. Sci. 1995, 35, 59-67.
27. Butina, D. Unsupervised Data Base Clustering Based on Daylight's Fingerprints and Tanimoto Similarity: A Fast and Automated Way To Cluster Small and Large Data Sets. J. Chem. Inf. Comput.-Sci. 1999, 39, 747-750.
28. Clark, M.; Cramer, R. D. III; Van Opdenbosch, N. Validation of the General Purpose Tripos 5.2 Force Field. J. Comput. Chem. 1989, 10, 982-1012.
29. Fonseca, C. M.; Fleming, P. J. Multiobjective optimization and multiple constraint handling with evolutionary algorithms. I. A unified formulation. IEEE Trans. Syst. Man. Cybernet. Part A—Syst. Humans 1998, 28, 26-37.
30. Baber, J. C.; Thompson, D. C.; Cross, J. B.; Humblet, C. GARD: A Generally Applicable Replacement for RMSD. J. Chem. Inf. Model. 2009, 49, 1889-1900.
31. Borg, I.; Groenen, P. J. F. Modern Multidimensional Scaling, 2^{nd} Ed. Springer, N.Y., 2005, pp. 187-194.
32. Verdonk, M. L.; Mortenson, P. N.; Hall, R. J.; Hartshorn, M. J.; Murray, C. W. Protein-Ligand Docking against Non-Native Protein Conformers. J. Chem. Inf. Model. 2008, 48, 2214-2225.
33. Hendlich, M.; Bergner, A.; Gunther, J.; Klebe, G. Relibase—Design and Development of a Database for Comprehensive Analysis of Protein-Ligand Interactions. J. Mol. Biol. 2003, 326, 607-620.
34. Sadowski, J.; Gasteiger, J.; Klebe, G. Comparison of automatic three-dimensional model builders using 639 X-ray structures. J. Chem. Inf. Comput. Sci. 1994, 34, 1000-1008.
35. SZYBKI—Molecular Structure Optimization in situ with MMFF94, OpenEye Scientific Software Inc., Sante Fe, N. Mex., USA. www.eyesopen.com.
36. Cheeseright, T.; Mackey, M.; Rose, S.; Vinter, A. Molecular Field Extrema as Descriptors of Biological Activity: Definition and Validation. J. Chem. Inf. Model. 2006, 46, 665-676.

1. A computer-based method of aligning a plurality of molecules, the method including the steps of:
(i) providing one or more conformers for each molecule, each conformer having a plurality of fitting points, each fitting point representing the position of a pharmacophore feature;
(ii) identifying triplets for each conformer, each triplet being a triangular arrangement of three fitting points in the conformer;
(iii) determining a triplet type for each triplet, each triplet type being defined by (a) the types of pharmacophore features at the three fitting points and (b) the inter-fitting point distances of the three fitting points;
(iv) identifying a base triplet type, which is a triplet type provided by a triplet of at least one conformer of each of a plurality of the molecules;
(v) rotating and translating the conformers having the base triplet type to overlay the conformers so that the triplets providing the base triplet type are superposed in the same orientation;
(vi) for each overlayed conformer, determining a respective bit string fingerprint which encodes the 3D positions of the conformer's fitting points and their respective pharmacophore features relative to the triplet providing the base triplet type; and
(vii) aligning the molecules by searching the bit string fingerprints for combinations of overlayed conformers, each from a different molecule, which have high concordance in terms of pharmacophore points, a pharmacophore point being a cluster of fitting points from different molecules in the overlayed conformers, each fitting point in the cluster representing the same type of pharmacophore feature.

2. A method according to claim 1, wherein, in step (vi), the bit string fingerprints are combined into a fingerprint table in which each row of the table corresponds to a different bit string fingerprint and each column of the table corresponds to a particular 3D position and type of pharmacophore feature, and, in step (vii), each high concordance combination is scored for concordance by logically combining the columns of the table for the rows of the table corresponding to the conformers of that combination.

3. A method according to claim 2, wherein, in step (vi), empty columns of the table are eliminated.

4. A method according to claim 1, wherein, in step (vi), the 3D positions of the conformer's fitting points are encoded in the respective bit string fingerprint by assigning bits in the bit string to respective grid points of a 3D grid of points, a bit being set “on” if the respective grid point of the 3D grid of points is the nearest grid point to a fitting point.

5. A method according to claim 4, wherein each grid point is encoded a plurality of times in the fingerprint for respective pharmacophore feature types, and a bit is set “on” if, in addition to the respective grid point of the 3D grid of points being the nearest grid point to a fitting point, the bit corresponds to the pharmacophore feature type of that fitting point.

6. A method according to claim 4, wherein nearest-neighbour bits of the nearest grid point to a fitting point are also set “on”.

7. A method according to claim 4, wherein bits falling within the volume envelope of the conformer are also set “on”.

8. A method according to claim 1, wherein steps (iv) to (vii) are performed again for further base triplet types.

9. A method according to claim 1, wherein, in step (iii), each triplet type extends over respective ranges of the inter-fitting point distances of the three fitting points, the ranges of the triplet type determined for each triplet enclosing the values of the respective inter-fitting point distances of the three fitting points of that triplet.

10. A method according to claim 9, wherein steps (iii) to (vii) are repeated two or more times, the beginning and end values of the ranges of the inter-fitting point distances of the triplet types being altered for each repeat.

11. A method according to claim 1, including a further step of:
(viii) filtering the high concordance combinations from the or each execution of step (vii) to produce a smaller subset of high concordance combinations.

12. A method according to claim 11, wherein step (viii) includes the sub-steps of:
(viii-1) scoring the high concordance combinations using an objective function;
(viii-2) selecting the high concordance combination having the best value of the objective function;
(viii-3) removing high concordance combinations that are similar to the combination selected in sub-step (viii-2); and
(viii-4) repeating sub-steps (viii-2) and (viii-3) one or more times for the remaining high concordance combinations;
wherein the selected the high concordance combinations form the subset.

13. A method according to claim 11, including the further steps of:
(ix) for each high concordance combination in the subset, merging the fitting points of the overlayed conformers to generate an arrangement of fitting points corresponding to a conformer of a notional supermolecule having the combined pharmacophore features of the molecules; and
(x) repeating steps (ii) to (vii) with the conformers of these steps being the supermolecule conformers and the conformers of one or more other molecules.

14. A method according to claim 13, including a further step of:
(xi) filtering the high concordance combinations resulting from the performance of step (x) to produce a smaller subset of high concordance combinations.

15. A method according to claim 1, wherein the molecules are known ligands of a given organic or biological macromolecule, such as a protein molecule.

16. The method of claim 15, further including:
screening, in silico, a compound database for possible ligands of the macromolecule by identifying compounds which have arrangements of pharmacophore features which are the same as or similar to the arrangements of pharmacophore points found in high concordance combinations from step (vii).

17. The method of claim 15, further including:
designing, in silico, compounds which are possible ligands of the macromolecule, the compounds having arrangements of pharmacophore features which are the same as or similar to the arrangements of pharmacophore points found in high concordance combinations from step (vii).

18. The method of claim 16, further including: obtaining or creating the possible ligands of the macromolecule; and
testing, in vitro, the possible ligands thus-obtained or created for binding activity with the macromolecule.

19. The method of claim 17, further including: obtaining or creating the possible ligands of the macromolecule; and
testing, in vitro, the possible ligands thus-obtained or created for binding activity with the macromolecule.

20. A computer system for performing the method of claim 1.

21. A computer program product carrying a computer program for performing the method of claim 1.

22. A computer program for performing the method of claim 1.
